(19) United States
(12) Patent Application Publication
(10) Pub. No.: US 2024/0300016 A1
(43) Pub. Date: Sep. 12, 2024

(54) BONDED PRECISION INSERTS AND METHODS OF USE THEREOF

(71) Applicant: Divergent Technologies, Inc., Los Angeles, CA (US)

(72) Inventor: Ewan John Cooper BALDRY, Los Angeles, CA (US)

(21) Appl. No.: 18/601,649

(22) Filed: Mar. 11, 2024

Related U.S. Application Data
(60) Provisional application No. 63/451,519, filed on Mar. 10, 2023.

(51) Int. Cl. B22F 7/08; B22F 7/06; B33Y 40/00; B33Y 80/00

(52) U.S. Cl. CPC B22F 7/08; B22F 7/062; B33Y 40/00; B33Y 80/00

(57) ABSTRACT

A combination component with an additively manufactured (AM) component and a non-AM manufactured component and method of producing a combination component is described. The method includes joining the AM component with a non-AM component. The method further includes retaining the AM component, wherein the AM component has an AM component bonding portion and retaining the non-AM component, wherein the non-AM component has a non-AM component bonding portion that is configured to be bonded with the AM component bonding portion with a bond gap therebetween for absorbing dimensional variances in the AM component or the non-AM component.

### CROSS-REFERENCE TO RELATED APPLICATION

This application claims the benefit of U.S. Provisional Application No. 63/451,519, entitled “BONDED PRECISION INSERTS” and filed Mar. 10, 2023, which is expressly incorporated by reference herein in its entirety.

### BACKGROUND

### Field

The present disclosure relates to component combining an additively manufactured component with a non-additive manufactured component and methods of forming and assembling an additively manufactured component and a non-additive manufactured component.

### Background

Additive manufacturing (AM) systems can produce metal structures (referred to as build pieces) with geometrically complex shapes, including some shapes that are difficult or impossible to create with conventional manufacturing processes. (AM) techniques are used to create build pieces layer-by-layer, i.e., slice-by-slice. The process can be repeated to form the next slice of the build piece, and so on. Because each layer is deposited on the previous layer, AM allows for the formation of structures that were previously not possible to be formed by traditional non-AM manufacturing technologies.

While AM provides several advantages, frequently any one or combination of efficiency, cost, dimensional accuracy requirements, dimensional stability requirements, and/or scale of a project may result in AM not being ideal for formation of all components.

### SUMMARY

The following presents a simplified summary of one or more aspects of the invention in order to provide a basic understanding of such aspects. This summary is not an extensive overview of all contemplated aspects and is intended to neither identify key or critical elements of all aspects nor delineate the scope of any or all aspects. Its purpose is to present some concepts of one or more aspects in a simplified form as a prelude to the more detailed description that is presented later.

Aspects of the disclosure relate to a method of producing a vehicle component by joining an additively manufactured (“AM”) component with a machined component. The method may include retaining the AM component with a first robot, wherein the AM component has an AM component bonding portion and retaining the machined component with a second robot, wherein the machined component has a machined component bonding portion that is configured to be bonded with the AM component bonding portion with a bond gap therebetween. The bond gap may be provided for absorbing dimensional variances in the AM component. The method may further include adjusting one of a position of the machined component or the AM component to achieve a designated alignment of the AM component with the machined component, wherein an adhesive in the bond gap bonds the AM component bonding portion and the machined component bonding portion.

Aspects of the disclosure further relate to a combination vehicle component. The vehicle component may include an additively manufactured (“AM”) component with an AM component bonding portion and a non-AM component with a non-AM component bonding portion. The vehicle component may further include a bonding agent within a bond gap between the AM component bonding portion and the non-AM component bonding portion, wherein the bonding agent in the bond gap between AM component and the non-AM component permanently connects the AM component with the non-AM component.

In additional aspects of the disclosure, methods of producing a vehicle component are described. The method may include producing a combination component by joining an additively manufactured (“AM”) component with a non-AM component. The method may further include retaining the AM component, wherein the AM component has an AM component bonding portion and retaining the non-AM component, wherein the non-AM component has a non-AM component bonding portion that is configured to be bonded with the AM component bonding portion with a bond gap therebetween for absorbing dimensional variances in the AM component or the non-AM component. The method may further include adjusting one of a position of the non-AM component or the AM component to achieve a designated alignment of the AM component with the non-AM component, wherein an adhesive in the bond gap bonds the AM component bonding portion and the non-AM component bonding portion.

It will be understood that other aspects of combined components and methods for producing components will become readily apparent to those skilled in the art from the following detailed description, wherein it is shown and described in the detailed examples by way of illustration. As will be realized by those skilled in the art, the disclosed subject matter may be varied or modified, all without departing from the present disclosure. Accordingly, the drawings and detailed description are to be regarded as illustrative in nature and not as restrictive.

### BRIEF DESCRIPTION OF THE DRAWINGS

FIGS. 1A-1D illustrate example powder bed fusion (PBF) systems during different stages of operation.

FIG. 2 illustrates one example of a wire directed energy deposition (DED) AM apparatus.

FIG. 3 illustrates an example of certain aspects of a direct metal deposition (DMD) AM apparatus.

FIG. 4A illustrates one example of a non-AM apparatus and method according to aspects of the disclosure.

FIG. 4B illustrates another example of a non-AM apparatus and method according to aspects of the disclosure.

FIG. 5 illustrates a flow diagram of example methods of forming a combined component according to aspects of the disclosure.

FIGS. 6A-6E illustrate an example assembly system, which includes a plurality of robots configured to perform various example operations for assembly of a combined component according to aspects of the disclosure.

FIGS. 7A-7D illustrate example components of a combined component according to aspects of the disclosure.

FIGS. 8A-8C illustrate an example of the interaction of the components of FIGS. 7A-7D during assembly into a combined component according to aspects of the disclosure.

FIG. 9 illustrates a combined component according to aspects of the disclosure.

FIG. 10 illustrates an example representative diagram of various components of an example controller usable with aspects of the disclosure.

FIG. 11 illustrates an example of a computer system in accordance with aspects of the disclosure.

FIG. 12 illustrates an example of various system components in accordance with aspects of the present disclosure.

### DETAILED DESCRIPTION

The detailed examples set forth below in connection with the appended drawings is intended to provide a description of various exemplary embodiments of the concepts disclosed herein and is not intended to represent the only embodiments in which the disclosure may be practiced. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram or simplified form, or omitted entirely, to avoid obscuring the various concepts presented throughout this disclosure.

### I. Terminology

Reference throughout this specification to one aspect, an aspect, one example or an example means that a particular feature, structure or characteristic described in connection with the embodiment or example may be a feature included in at least example of the present invention. Thus, appearances of the phrases in one aspect, in an aspect, one example or an example in various places throughout this specification are not necessarily all referring to the same example. Furthermore, the particular features, structures or characteristics may be combined in any suitable combinations and/or sub combinations in one or more embodiments or examples.

The term exemplary used in this disclosure means serving as an example, instance, or illustration, and should not necessarily be construed as preferred or advantageous over other embodiments presented in this disclosure.

Throughout the disclosure, the terms substantially or approximately may be used as a modifier for a geometric relationship between elements or for the shape of an element or component. While the terms substantially or approximately are not limited to a specific variation and may cover any variation that is understood by one of ordinary skill in the art to be an acceptable level of variation, some examples are provided as follows. In one example, the term substantially or approximately may include a variation of less than 10% of the dimension of the object or component. In another example, the term substantially or approximately may include a variation of less than 5% of the object or component. If the term substantially or approximately is used to define the angular relationship of one element to another element, one non-limiting example of the term substantially or approximately may include a variation of 5 degrees or less. These examples are not intended to be limiting and may be increased or decreased based on the understanding of acceptable limits to one of skill in the relevant art.

For purposes of the disclosure, directional terms are expressed generally with relation to a standard frame of reference when the aspects or articles described herein are in an in-use orientation. In some examples, the directional terms are expressed generally with relation to a left-hand coordinate system.

Terms such as a, an, and the, are not intended to refer to only a singular entity, but also include the general class of which a specific example may be used for illustration. The terms a, an, and the, may be used interchangeably with the term at least one. The phrases at least one of and comprises at least one of followed by a list refers to any one of the items in the list and any combination of two or more items in the list. All numerical ranges are inclusive of their endpoints and non-integer values between the endpoints unless otherwise stated.

The terms first, second, third, and fourth, among other numeric values, may be used in this disclosure. It will be understood that, unless otherwise noted, those terms are used in their relative sense only. In particular, certain components may be present in interchangeable and/or identical multiples (e.g., pairs). For these components, the designation of first, second, third, and/or fourth may be applied to the components merely as a matter of convenience in the description.

The term additive manufacturing (AM) or AM component may be used throughout the disclosure. The term AM includes any known additive manufacturing or 3D printing technique. Some examples include but are not limited to power bed fusion, direct energy deposit (DED), fused deposition modeling (FDM), stereolithographic (SLA), wire or extrusion-based DED. Accordingly, all additive manufacturing and 3D printing techniques are applicable without departing from the principles of this disclosure including those that are currently contemplated or under commercial development. The aspects of the disclosure may additionally be relevant to non-metal additive manufacturing and or metal/adhesive additive manufacturing (e.g., binderjetting), which may forgo an energy beam source and instead apply an adhesive or other bonding agent to form each layer. In the case of binderjetting, the cured or green form may be sintered or fused in a furnace and/or be infiltrated with bronze or other alloys.

The terms powder bed fusion (PBF) is used throughout the disclosure. PBF systems may encompass a wide variety of additive manufacturing (AM) techniques, systems, and methods. Thus, the PBF system or process as referenced in the disclosure may include, among others, the following printing techniques: direct metal laser sintering (DMLS), electron beam melting (EBM), selective heat sintering (SHS), selective laser melting (SLM) and selective laser sintering (SLS). PBF fusing and sintering techniques may further include, for example, solid state sintering, liquid phase sintering, partial melting, full melting, chemical binding and other binding and sintering technologies.

The term fusing may be used throughout the disclosure to describe any permanent fixing or adhering of AM powder or other known materials. In some examples, the term fusing may include sintering, melting, and/or adhering (e.g., via bonding agent or adhesive) individual powder particles.

The term non-AM manufacturing may be used throughout the disclosure to encompass any manufacturing technique other than AM. Some examples may include any one or combination of subtractive manufacturing techniques (e.g., machining) and/or extrusions, stampings, forgings, moldings, or castings, to name a few non-limiting examples. Further, non-AM may refer to any known method for forming non-metallic components. For example, non-AM may also encompass components formed of composites including any one or combination of carbon fibers, para-aramid (Kevlar™), fiberglass, or substrates thereof that are bonded or otherwise laminated via a synthetic polymer (e.g., epoxy, vinyl ester, polyester resins or combinations thereof).

The term structural component in a vehicle may include but is not limited to a frame, subframe, or a component that receives a load due to vehicle driving dynamics. In some examples, the term structural component may distinguish from other vehicle components, e.g., seats, steering wheel, exhaust, etc.

### II. Detailed Examples

Additive Manufacturing (AM) systems can produce structures with geometrically complex shapes, including some shapes that are difficult or impossible to create with conventional manufacturing processes. Further, AM systems provide unmatched efficiency in quickly producing components and for freedom in designing and quickly changing structures as needs change or as structures are further optimized without needing to re-tool as is typically required using conventional non-AM manufacturing processes. Non-AM components and manufacturing processes also have their own set of advantages. For example, with tooling, non-AM components can be manufactured in large quantities at reduced cost. Further, in some cases non-AM components can be produced with greater dimensional accuracy and consistency that AM components. For example, machined components or components formed with other subtractive manufacturing techniques are typically understood to have very good and sometimes unmatched dimensional accuracy.

The present disclosure describes combination components and techniques and approaches to manufacture and/or assemble at least a portion of a vehicle or other combination components by combining AM components and non-AM or traditionally formed components. By utilizing the aspects described herein, the combination components described herein combine the advantages of both AM components and non-AM formed components. For example, in the context of a vehicle component or combined component or structure, a part of a larger structure may be formed using AM manufacturing due to any one or combination of efficiency concerns, packaging, desired strength, weight and/or known stresses and ability to optimize AM components to known stresses. Other sections of a vehicle component may be formed using non-AM techniques, for example to provide any one or combination of consistent dimensional accuracy, reduced cost, and/or specific material qualities (e.g., hardness, toughness, dimensional stability). Additional aspects of this disclosure are related the assembly of components to form combination components and in some examples to methods of ensuring that the AM components and non-AM or traditionally formed components are properly aligned and/or provide a robust combined structure. Further details and examples are provided in the detailed examples that follow.

An additively manufactured (AM) component may be formed using several methods, examples of which are provided below. However, it is noted that AM components according to aspects of this disclosure are not limited to components formed using the methods described in the examples below. AM components may be formed by any manufacturing method that allows for freedom of design and/or quick manufacturing, even if at the expense of preciseness of the component.

Additive manufacturing (AM) systems, such as powder bed fusion (PBF) systems can produce structures (referred to as build pieces) with geometrically complex shapes, including some shapes that are difficult or impossible to create with conventional manufacturing processes. PBF systems create build pieces layer-by-layer, i.e., slice-by-slice. Each slice can be formed by a process of depositing a layer of powder (e.g., metal or metallic powder) and fusing (e.g., melting and cooling) areas of the metal powder layer that coincide with the cross-section of the build piece in the slice. The process can be repeated to form the next slice of the build piece, and so on.

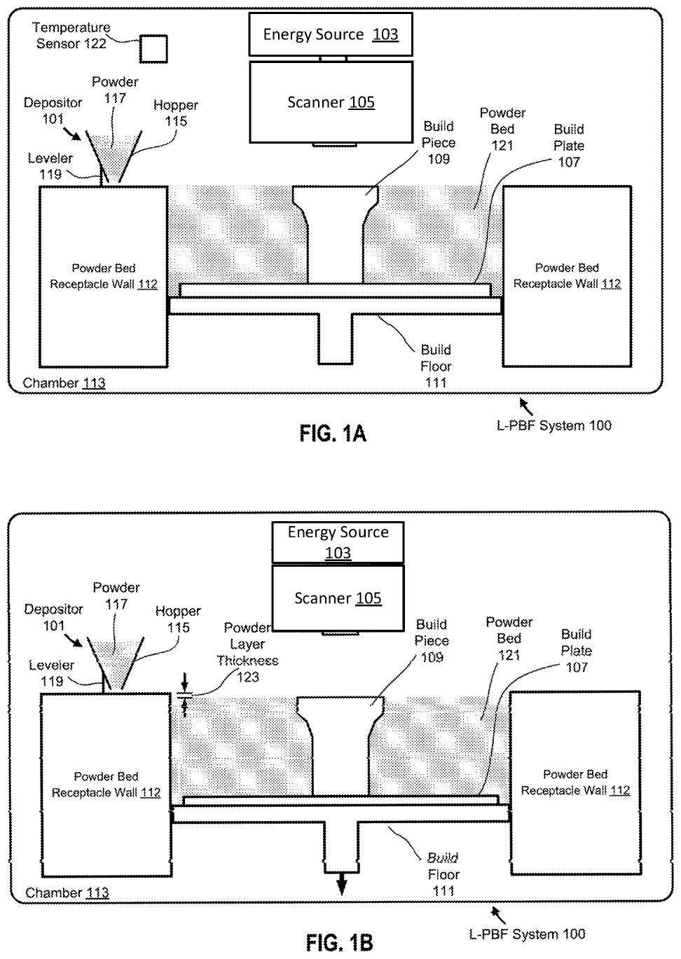

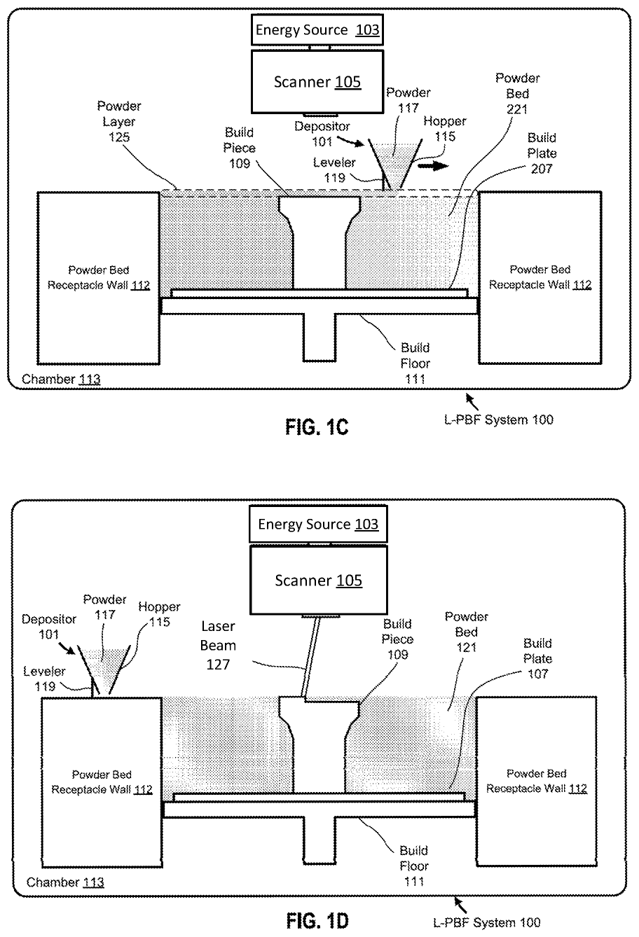

FIGS. 1A-D illustrate respective side views of an example of a PBF system 100 usable with aspects of the disclosure during different stages of operation. As noted above, the particular embodiment illustrated in FIGS. 1A-D is one of many suitable examples of a PBF system employing principles of this disclosure. It should also be noted that elements of FIGS. 1A-D and the other figures in this disclosure are simplified and not necessarily drawn to scale, but may be drawn larger or smaller and/or with reduced detail for the purpose of better illustration of concepts described herein. PBF system 100 can include a depositor 101 that can deposit each layer of metal powder, an energy beam source 103 that can generate an energy beam, a scanner 105 that can direct or redirect the energy beam to fuse the powder material, and a build plate 107 that can support one or more build pieces, such as a build piece 109.

PBF system 100 can also include a build floor 111 positioned within a powder bed receptacle. The walls of the powder bed receptacle 112. Build floor 111 can progressively lower build plate 107 so that depositor 101 can deposit a next layer. In some examples, the entire mechanism may reside in a chamber 113 that can enclose the other components, thereby protecting the equipment, enabling atmospheric (e.g., providing an inert environment) and temperature regulation and mitigating contamination risks. Depositor 101 can include a hopper 115 that contains a powder 117, such as a metal powder, and a leveler 119 that can level the top of each layer of deposited powder.

Referring specifically to FIG. 1A, this figure shows PBF system 100 after a slice of build piece 109 has been fused, but before the next layer of powder has been deposited. In fact, FIG. 1A illustrates a time at which PBF system 100 has already deposited and fused a partially completed build piece in multiple layers to form the current state of build piece 109. The multiple layers already deposited have created a powder bed 121, which includes powder that was deposited but not fused.

FIG. 1B shows PBF system 100 at a stage in which build floor 111 can lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, depositor 101 moves over the defined space while releasing powder 117 from hopper 115. Leveler 119 can level the released powder to form a powder layer 125 that has a thickness substantially equal to the powder layer thickness 123 (see FIG. 1B). Thus, the powder in a PBF system can be supported by a powder material support structure, which can include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving 150 previously-deposited layers discussed above with reference to FIG. 1A.

FIG. 1D shows PBF system 100 at a stage in which, following the deposition of powder layer 125 (FIG. 1C), energy beam source 103 generates an energy beam 127 and a scanner 105, directs, and/or redirects the energy beam along the surface of the powder layer 125 to melt, sinter, and/or melt the next slice in build piece 109. In various aspects of the disclosure, energy beam source may be one or more lasers 103, in which case energy beam 127 is a laser beam. The scanner may include one or more motors, galvos, gimbals, optics, etc. Controlling one or more mirrors and/or lenses for reflection and/or refraction to manipulate the laser beam to scan selected areas of the powder layer may include an optical system that uses one or more motors controlling one or more mirrors and/or lenses for reflection and/or refraction to manipulate the laser beam to scan selected areas of the powder layer 125 to be fused. The scanner 105 may include one or more gimbals and actuators, which may be motor-controlled, that can rotate and/or translate the energy beam source to position the energy beam and/or optics such as a focusing or de-focusing optic or optics to allow for focusing/de-focusing of the energy beam. In various aspects, energy beam source 103 and/or scanner 105 can modulate the energy beam, e.g., turn the energy beam on and off and/or control the divergence of the energy beam 103 as the scanner 105 scans so that the energy beam is applied only in the appropriate areas of the powder layer(s) and/or to control the energy applied to the powder layer(s). For example, in various aspects of the disclosure, the energy beam can be modulated by a digital signal processor (DSP). The deflector may include any known system in the art, for example a galvo-scanner or galvanometer, and/or a raster scanner. It is noted that while a single energy beam source 103 and/or scanner 105 is shown, aspects of the disclosure are usable with and may include a system with multiple energy source(s) and/or scanners.

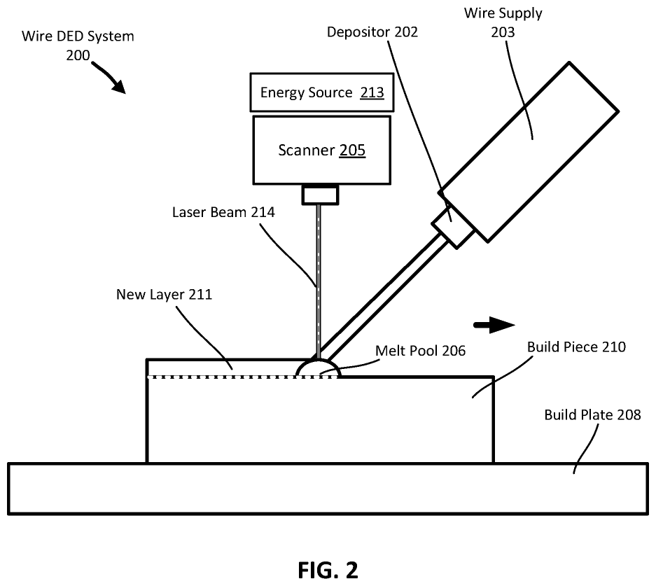

FIG. 2 illustrates an example wire Directed Energy Deposition (“DED”) system 200 for AM using wire or extrusions. A wire DED system 200 can include a depositor 202 that can deposit each layer of wire or extruded material from a supply apparatus 203, a laser 203 or other energy source can generate heat to melt each layer of material upon deposition and form a melt pool 206, and a build plate 208 that can support one or more build pieces, such as build piece 210. The example of FIG. 2 shows wire DED system 200 after multiple layers of build piece 210 have each been deposited, and while a new layer 212 is being deposited. While depositing the new layer, build piece 210 can remain stationary, and depositor 202 and laser 204 can cross a length and width of the build piece while releasing wire and generating heat, respectively. Alternatively, or in combination with movement of the laser 203, the build piece 210 can move under the depositor and laser 203. The laser 204 may generate a laser beam 114, which may pass through or otherwise be affected by an optical system scanner 205 that uses reflection and/or refraction to manipulate the laser beam to scan selected areas to be fused.

In various aspects of the disclosure, the scanner 205 can include one or more gimbals and actuators that can rotate and/or translate the laser source to position the energy beam. By controlling the scanner 205, the laser beam 214 can be scanned in the x-direction and/or y-direction to allow for scanning of the laser over the wire or an extrusion from the depositor 202. In various aspects, energy beam source 103 and/or the scanner 205 can modulate the energy beam, e.g., turn the energy beam on and off and/or focus/de-focus the beam as the scanner 205 scans so that the energy beam is applied only in the appropriate areas of the wire or extrusion provided by the depositor. For example, in various aspects of the disclosure, the energy beam can be modulated by a digital signal processor (DSP). The scanner 205 may include any known system in the art, for example a galvo-scanner or galvanometer, and/or a raster scanner. It is noted that while a single energy beam source 203 and/or scanner 205 is shown, aspects of the disclosure are usable with and may include a system with multiple energy source(s) and/or deflector(s).

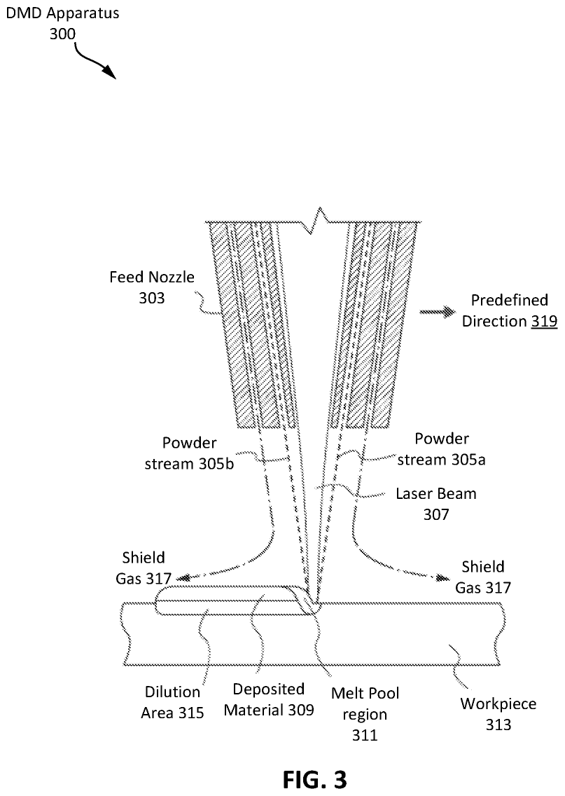

In another example of the AM techniques that can be used to form an AM component, is direct metal deposition (DMD). FIG. 3 illustrates an example embodiment of certain aspects of a DMD apparatus 300. DMD apparatus 300 uses a feed nozzle 303 moving in a predefined direction 319 to propel powder streams 305a and 305b into a laser beam 307, which is directed toward a workpiece 313 that may be supported by a substrate. Feed nozzle 303 may also include mechanisms for streaming a shield gas 317 to protect the welded area from oxygen, water vapor, or other components.

The powdered metal is then fused by laser 307 in a melt pool region 311, which may then bond to workpiece 313 as a region of deposited material 309. A dilution area 315 may include a region of workpiece 313 where the deposited powder is integrated with the local material of workpiece 313. Feed nozzle 303 may be supported by a computer numerical controlled (CNC) robot or a gantry, or other computer-controlled mechanism. Feed nozzle 303 may be moved under computer control multiple times along a predetermined direction of the substrate until an initial layer of deposited material 309 is formed over a desired area of workpiece 313. Feed nozzle 303 can then scan the region immediately above the prior layer to deposit successive layers until the desired structure is formed. In general, feed nozzle 303 may be configured to move with respect to all three axes, and in some instances to rotate on its own axis by a predetermined amount.

When forming an AM component, a data model of the desired 3-D object to be manufactured is rendered. A data model is a virtual design of the 3-D object. Thus, the data model may reflect the geometrical and structural features of the 3-D object, as well as its material composition. The data model may be created using a variety of methods, including CAE-based optimization, 3-D modeling, photogrammetry software, and camera imaging. CAE-based optimization may include, for example, cloud-based optimization, fatigue analysis, linear or non-linear finite element analysis (FEA), and durability analysis.

3-D modeling software, in turn, may include one of numerous commercially available 3-D modeling software applications. Data models may be rendered using a suitable computer-aided design (CAD) package. Thereupon, CAD package may further implement error analysis steps under which the 3-D model may be analyzed, and errors identified and resolved.

Following error resolution, the data model can be ‘sliced’ by a software application known as a slicer to thereby produce a set of instructions for “3-D printing” the object, with the instructions being compatible and associated with the particular 3-D printing technology to be utilized. Numerous slicer programs are commercially available. Generally, the slicer program converts the data model into a series of individual layers representing thin slices (e.g., 50-500 microns thick or thicker if other AM methods besides PBF are implemented) of the object be printed, along with a file containing the AM apparatus specific instructions for printing these successive individual layers to produce a buildpiece or workpiece representation of the data model.

The layers associated with AM methods and related instructions need not be planar or identical in thickness. For example, in some embodiments depending on factors like the technical sophistication of the AM equipment and the specific manufacturing objectives, etc., the layers in the buildpiece structure may be non-planar and/or may vary in one or more instances with respect to their individual thicknesses.

In addition to the instructions that dictate what and how an object is to be formed, the appropriate physical materials necessary for use by AM apparatus in forming the buildpiece are provided to the AM apparatus using any of several conventional and often AM apparatus specific methods. In DMD techniques, for example, one or more metal powders may be provided for layering structures with such metals or metal alloys. In selective laser melting (SLM), selective laser sintering (SLS), and other PBF-based AM methods (see below), the materials may be provided as powders into chambers that feed the powders to a build platform. Depending on the AM apparatus, other techniques for providing printing materials may be used.

The respective data slices of the 3-D object are then printed based on the provided instructions using the material(s). In an AM apparatus that uses laser sintering, a laser scans a powder bed and melts the powder together where structure is desired as described above with respect to FIGS. 1A-1D, and avoids scanning areas where the sliced data indicates that nothing is to be printed. This process may be repeated until the desired structure or buildpiece is formed, after which the buildpiece is removed from the AM apparatus (either manually or in an automated process). In fused deposition modelling, as described above, parts are built by applying successive layers of model and support materials to a substrate. In general, any suitable AM technology or 3-D printing technology is contemplated and may be employed to form components described herein for purposes of the present disclosure.

As described herein, non-AM techniques may include any one or combination of subtractive manufacturing techniques (e.g., machining) and/or extrusions, stampings, forgings, moldings, or castings, to name a few non-limiting examples.

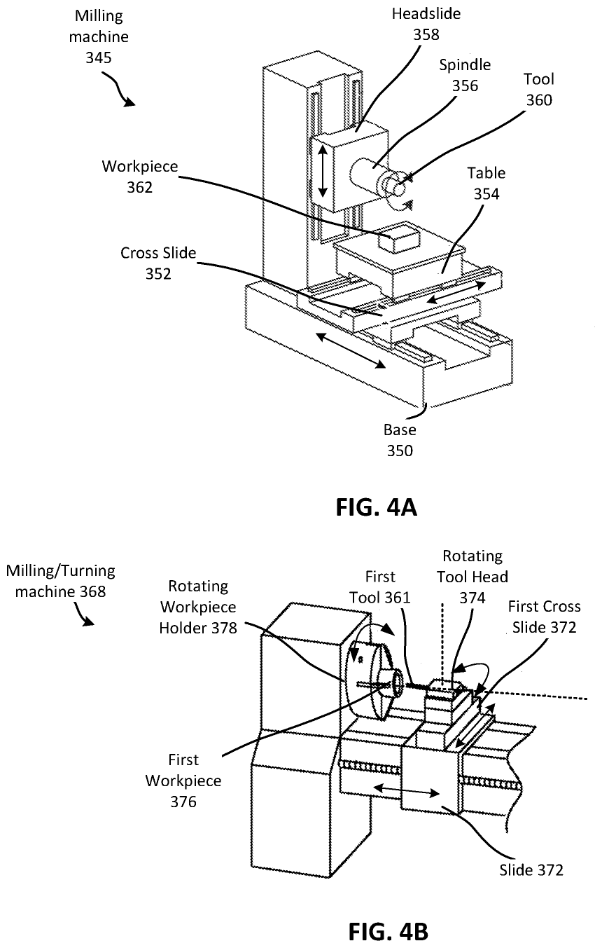

On example of a non-AM manufacturing technique is machining or milling. FIG. 4A shows one example of a milling machine usable with aspects of the disclosure. A milling machine may include a base 350 and a table to which a workpiece 362 is removably connected to (e.g., via clamping or other removable fastening means). The milling machine may further include a tool 360, which is configured to rotate via a spindle and remove material from a workpiece 362. The tool 360 may be interchangeable and may be switched-out manually or using an automated process as the milling process continues. The example milling machine 345 shown in FIG. 4 has three axes and may be referred to as a 3-axis milling machine. Namely, the table 354 is movable along a first axis and second axis with respect to the base via the cross slide 352. The headslide 358 is moveable along a third axis. It is noted that while a 3-axis milling machine with a single spindle is shown, non-AM components and methods contemplated in this disclosure can include any known number of spindles and may include milling machines from 2-axis to 12-axis.

FIG. 4B shows a simplified partial view of another example of a non-AM milling or machining technique. A non-AM milling or turning machine 368 may include a rotating workpiece holder 378 configured to rotate while removably holding a first workpiece 378. A first tool 361 may be removeably and exchangeably held in a rotating tool head 374. As the first workpiece 378 is rotated, the first tool is moved into contact with the workpiece 378 to remove raw material until the desired dimensions and geometry of the workpiece 378 is achieved. In the example shown in FIG. 4B, the rotating tool head is configured to rotate about a first axis, the first cross slide 372 is configured to translate about a second axis, and the slide is configured to translate along a third axis. While a 3-axis turning machine is shown in FIG. 4B, the non-AM components and methods contemplated in this disclosure can include any known number of tool heads and may include turning machines up to 6-axis.

Any one or combination of the non-AM manufacturing apparatuses described above may be manual controlled or may be full or partial (e.g., combined manual and automated) computer numerical control (CNC) manufacturing apparatuses with any one or all of the operations being computer controlled. Additional aspects of computer our automated control of the aspects described herein are described in further detail below. While examples are provided above, non-AM components contemplated by this disclosure are not limited to aspects or features listed or described herein and may include to any manufacturing technique other than AM manufacturing.

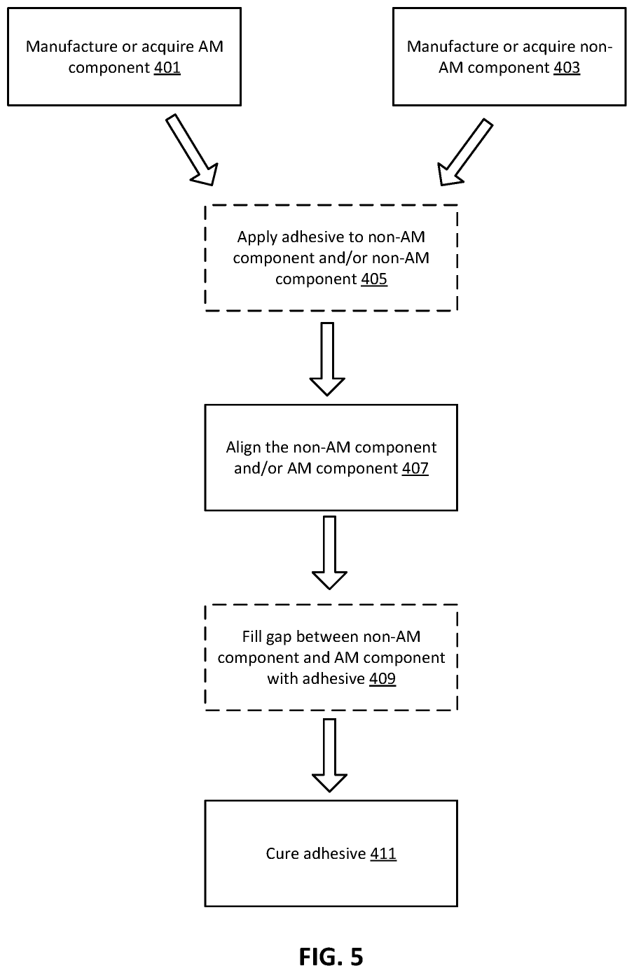

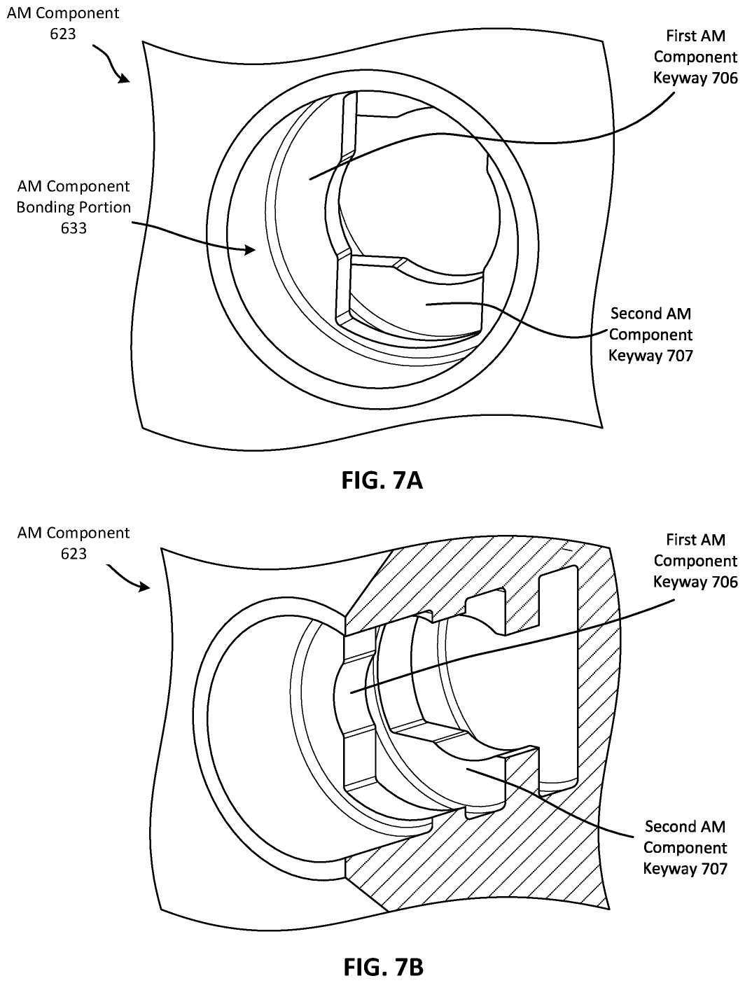

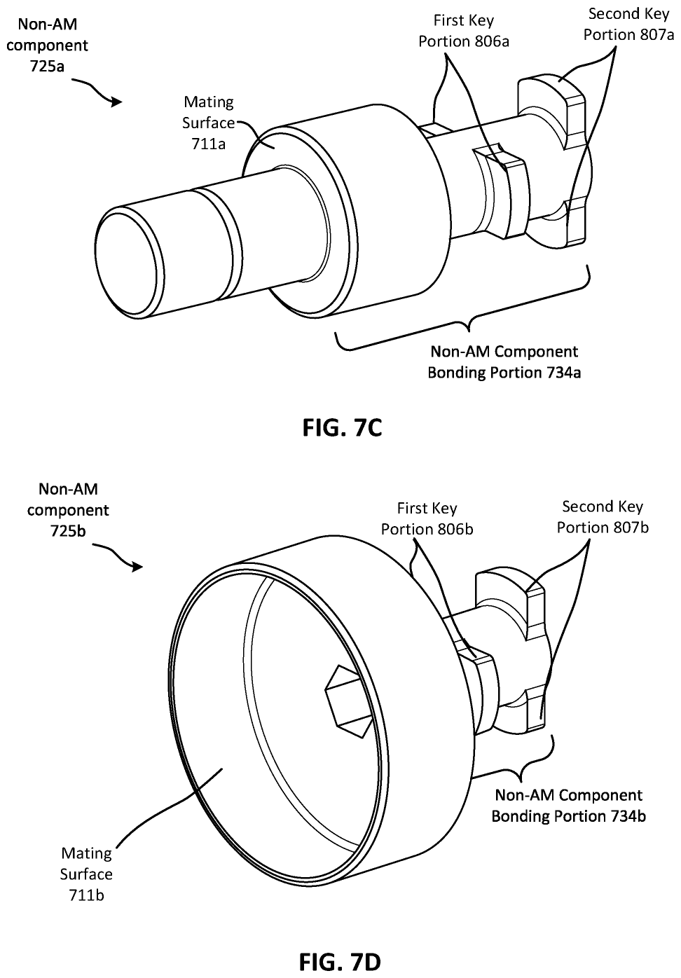

FIG. 5 is a flow diagram of a method of manufacturing a combined component according to aspects of this disclosure. In steps 401 and 403, one or more AM components may be acquired and/or manufactured (e.g., using any one or combination of the examples described above with respect to FIGS. 1A-2). Further, one or more non-AM components may be acquired and/or manufactured (e.g., using any one or combination of the examples described above with respect to FIGS. 4A-4B). Either one of or both of the non-AM component and the AM component may be manufactured with bonding portion(s) that include geometries to provide surfaces to bond the AM component and the non-AM component to one another. Further, the bonding portion(s) may include geometric features that allow for adjustment of the alignment of the two components either before or while the bonding agent or adhesive cures. Further, the AM components may include keyed features or other features that increase the surface area that contacts the bonding material and/or adhesive and/or that provided increased strength or redundancy to the bond between the two or more components. Specific, non-limiting examples of bonding portion(s) that include the aforementioned features are described below with respect to FIGS. 7A-9.

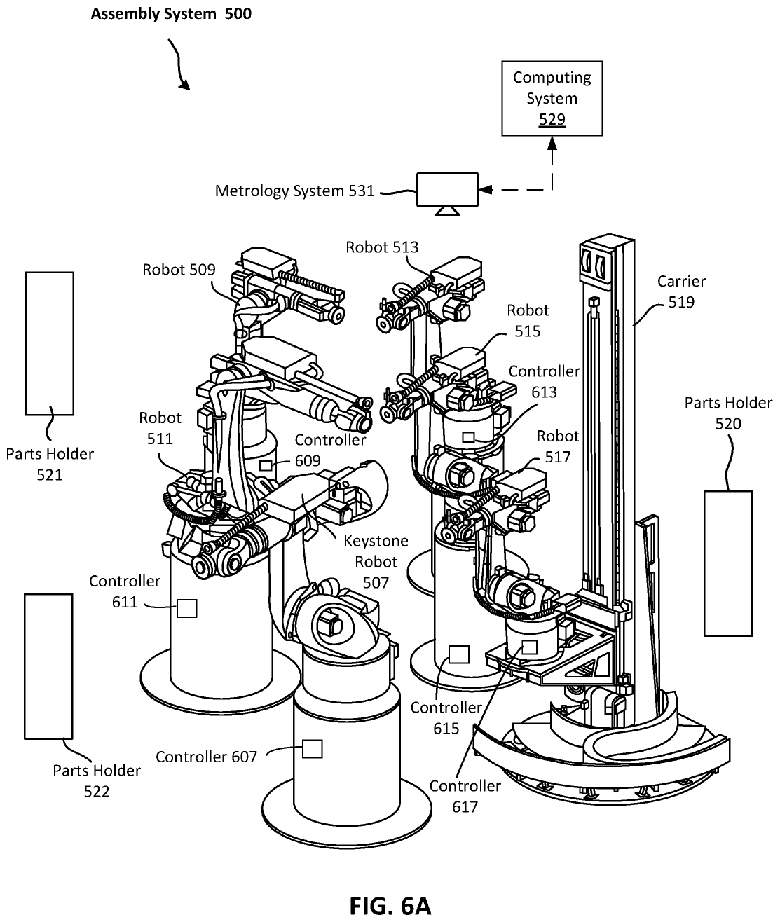

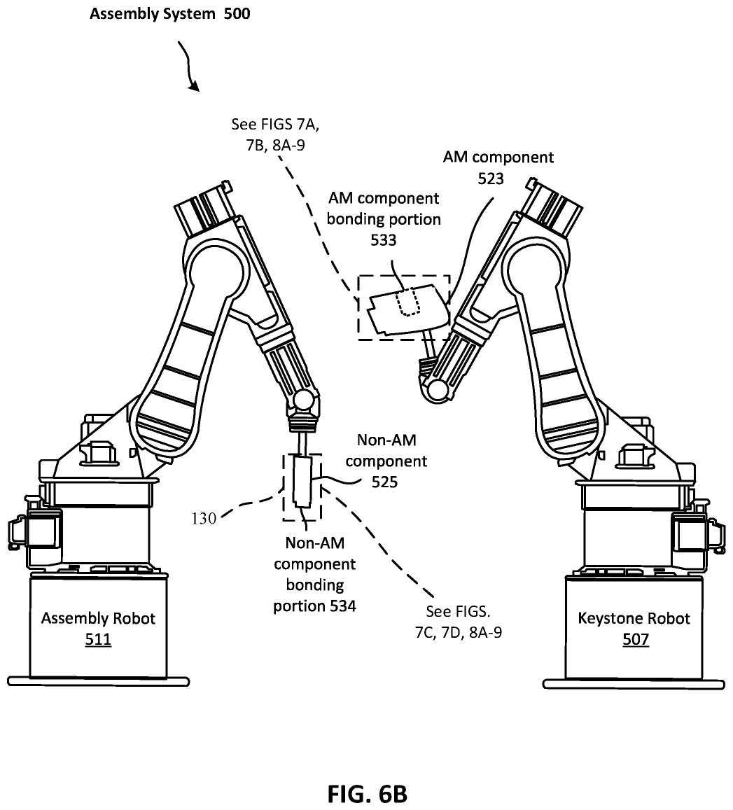

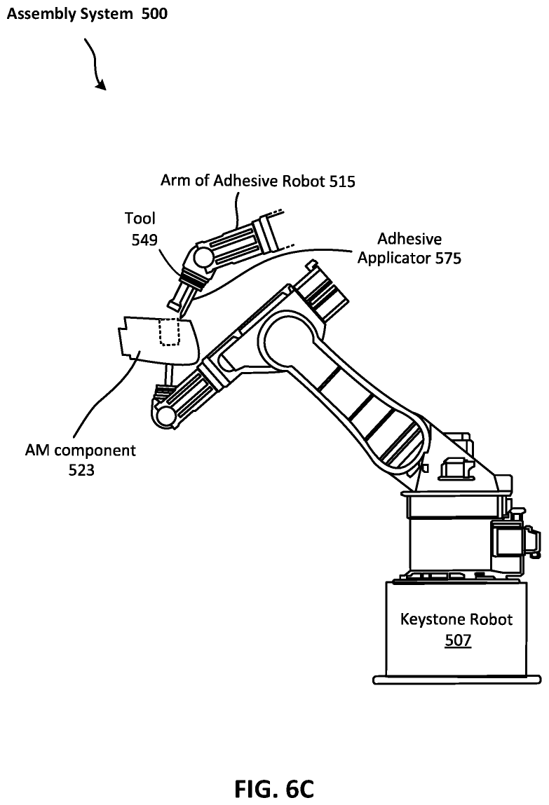

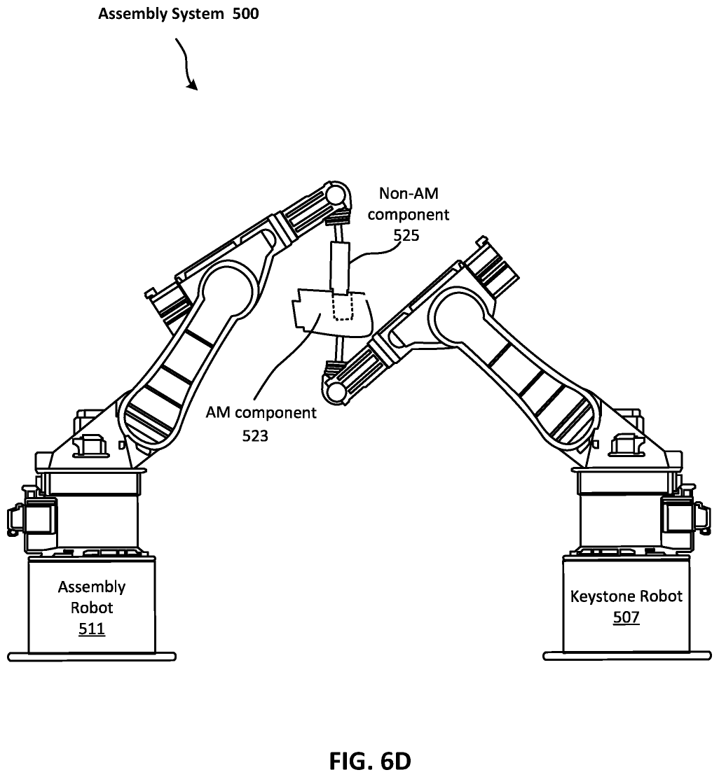

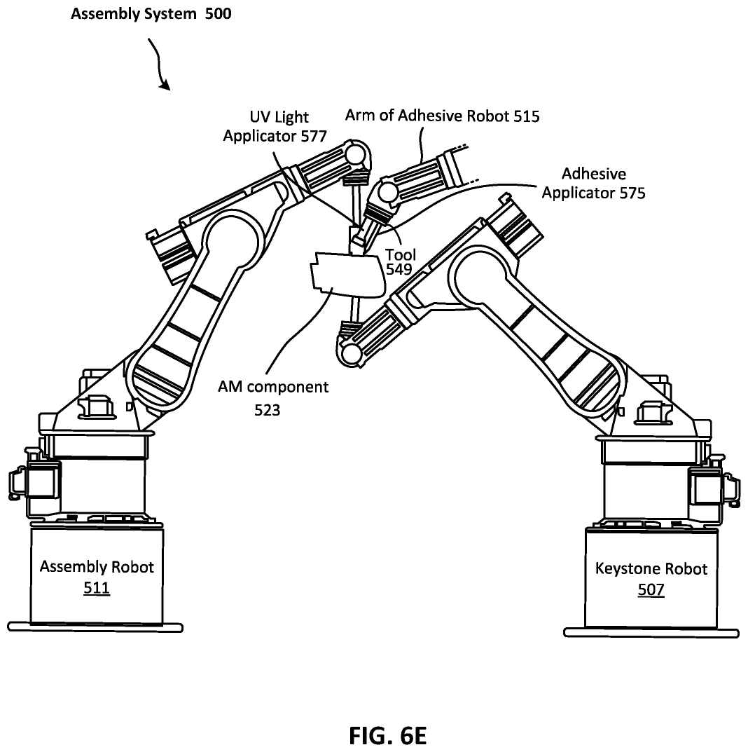

As shown in FIG. 5, once the AM component and non-AM components are either manufactured or acquired, an adhesive or bonding agent may be applied at step 405 to the aforementioned bonding portion(s) of the non-AM component and/or the AM component. The bonding agent or adhesive be any known adhesive or foaming adhesive. In some aspects, the connection media may be a two part curable adhesive such as an epoxy, urethane, or urethane foam, expanding or foaming adhesive, or other adhesive or bonding agent. In another example, the adhesive and/or foam may cure when heat is applied and thus the connected combination structure may be subjected to heating and/or placed in an autoclave or oven to cure the adhesive at the connection. In yet another example, the adhesive may be an ultraviolet (UV) curable adhesive or bonding agent that is configured to solidify or cure when subject to UV light. The adhesive may be applied at step 405 manually or via an automated process, such as with the fixtureless system described below with respect to FIGS. 6A-6D. It is noted that step 405 may be optional and the adhesive and/or bonding agent may instead be applied at step 409 as described below.

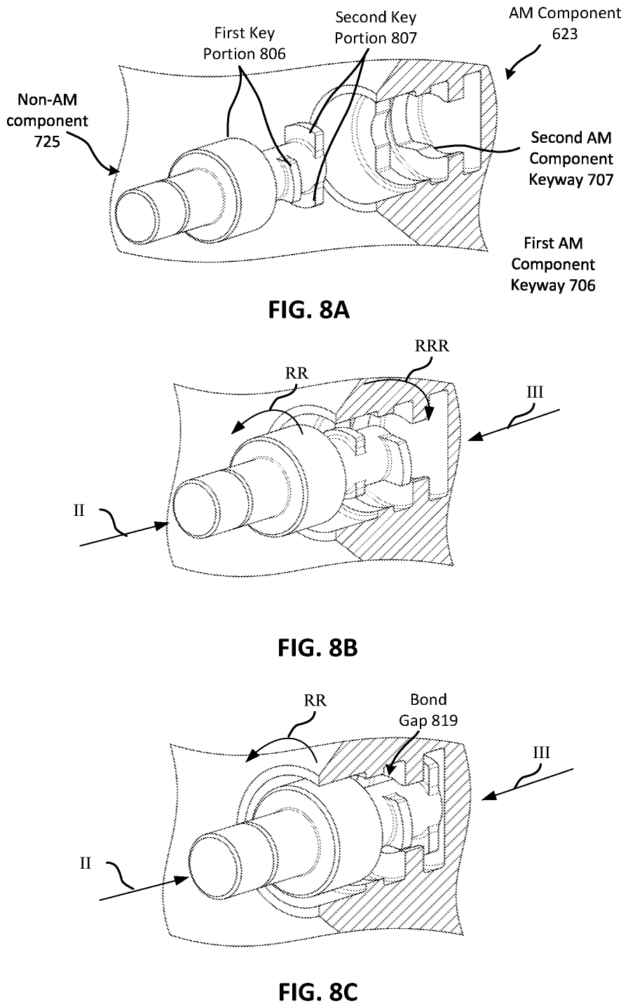

At step 407, the non-AM component and the AM component may be aligned and/or installed with respect to one another. As described in the examples shown in FIGS. 8A-8C, the alignment may include a series of linear translation and rotation steps to allow for proper installation and/or alignment of the non-AM component and the AM component. Further, once the non-AM component and the AM component are installed to one-another, additional alignment may take place to ensure that that surfaces or points on the non-AM component and/or the AM component are in proper alignment. For example, as described in the example show in FIGS. 8A and 8C, a bond gap may exist between bonding regions of the non-AM components and the AM component, which allows for additional alignment before the adhesive or bonding agent is cured at step 411 or while it is curing. As noted above, the bonding agent or adhesive may be applied either before the AM components and the non-AM component are aligned/installed to one another (e.g., as in step 405) and/or the bonding agent or adhesive may be applied after the components are aligned/installed to one another in step 409. If the bonding agent or adhesive is applied after the components are aligned/installed, the bonding agent or adhesive may be injected, in some examples under pressure, into a bond gap or space between the bonding portions of the AM component and the non-AM component.

The steps described above with respect to FIG. 5 may be partially automated or fully automated. For example, any one or combination of the manufacturing and/or acquiring steps 401 and/or 403, the adhesive or bonding agent application steps 405 and/or 409 and/or the alignment steps 407 and/or curing steps 411 may be partially or fully automated.

One example of the aforementioned automation includes an assembly system and/or method. FIGS. 6A-6E show non-limiting examples for automating the methods of manufacturing combined components described herein (e.g., as described above with respect to FIG. 5 and below with respect to FIGS. 8A-8C) with an assembly system 500. In one example, the assembly system 500 may be a fixtures assembly system. At least one of the structures of the disclosed component may be additively manufactured, e.g., as described with respect to FIGS. 1A-3 above. In some aspects, at least one of the at least two structures may be a piece, part, node, component, and/or other additively manufactured structure, which may include two structures that previously have been joined. For example, a structure or a part may be at least a portion or section associated with a vehicle, such as a vehicle chassis, panel, base piece, body, frame, suspension components, brake component, and/or another vehicle component that will be combined with one or more non-AM components.

The structures to be joined in association with assembly of a combined component may be manufactured with one or more features that may facilitate or enable various assembly operations (e.g., joining) without the use of fixtures, such as one or more features to prevent or reduce unintended movement of a structure and/or deflection of the structure during one or more fixtureless assembly operations. For example, one or more structures to be joined in association with fixtureless assembly of a vehicle may be additively manufactured with one or more features designed to provide stability, strength, and/or rigidity during various fixtureless assembly operations. Examples of such features may include mesh, honeycomb, and/or lattice substructures, which may be co-printed with a structure (e.g., when the structure is additively manufactured) and which may be internal and/or external to the structure.

In one example, an assembly system may include at least two robots, at least one of which may be positioned to join one structure with another structure without the use of fixtures. A first robot may be configured to engage with and retain a first structure to which one or more other structures may be joined during various operations performed in association with fixtureless assembly of at least a portion of a larger assembly. For example, the first robot may engage and retain a first structure that is or includes an AM component that is to be joined with a second structure that is or includes a non-AM component, and the second structure may be engaged and retained by a second robot. Various operations performed with the first structure (e.g., joining the first structure with one or more other structures, which may include two or more previously joined structures) may be performed at least partially within an assembly cell that includes a plurality of robots. Accordingly, at least one of the robots may be directed (e.g., controlled) during a fixtureless operation with the first structure in order to function in accordance with precision commensurate with the fixtureless operation.

The present disclosure provides various different aspects of directing one or more robots at least partially within an assembly system for assembly operations (including pre-assembly and/or post-assembly operations). It will be appreciated that various features described herein may be practiced together. For example, an example implementation described with respect to one illustration of the present disclosure may be implemented in another embodiment described with respect to another illustration of the present disclosure.

FIG. 5 illustrates a perspective view of an example assembly system 500. Assembly system 500 may be employed in various operations associated with the assembly of components, such as robotic assembly of a vehicle or components thereof. Assembly system 500 may include one or more elements associated with at least a portion of the assembly of a vehicle without any fixtures. For example, one or more elements of assembly system 500 may be configured for one or more operations in which a first structure is joined with one or more other structures without the use of any fixtures during robotic assembly.

Assembly system 500 may include a set of robots 507, 509, 511, 513, 515, 517. Robot 507 may be referred to as a “keystone robot.” Assembly system 500 may include parts holders 520, 521, and 522 that can hold parts and structures for the robots to access, which may for example AM components or non-AM components as described herein. For example, an AM component 523, a non-AM component 525, and a third structure 527 may be positioned on one of parts holders 521, 522 to be picked up by the robots and assembled together.

Assembly system 500 may also include a computing system 529 to issue commands to the various controllers of the robots of assembly cell 505, as described in more detail below. In this example, computing system 529 is communicatively connected to the robots through a wireless communication. Assembly system 500 may also include a metrology system 531 that can accurately measure the positions of the robotic arms of the robots and/or the structures held by the robots. As noted above, in some examples, the structures need not be connected within any fixtures. Instead, at least one of the robots in assembly cell 505 may provide the functionality expected from fixtures, as described in this disclosure. For example, robots may be configured to directly contact (e.g., using an end effector of a robotic arm) structures to be assembled within assembly cell 505 so that those structures may be engaged and retained without any fixtures. Further, at least one of the robots may provide the functionality expected from the positioner and/or fixture table. For example, keystone robot 507 may replace a positioner and/or fixture table in assembly system 500.

Keystone robot 507 may include a base and a robotic arm. The robotic arm may be configured for movement, which may be directed by computer-executable instructions loaded into a processor communicatively connected with keystone robot 507.

Keystone robot 507 may include and/or be connected with an end effector that is configured to engage and retain a structure, e.g., a first component for assembly. An end effector may be a component configured to interface with at least one structure. Examples of the end effectors may include jaws, grippers, pins, or other similar components capable of facilitating fixtureless engagement and retention of a structure by a robot. In some embodiments, the structure may be a section of a vehicle chassis, body, frame, panel, base piece, suspension component, knuckle, brake components, and the like. For example, the structure may comprise a suspension component that was formed using an AM process.

Keystone robot 507 may retain the connection with a structure through an end effector, while a set of other structures is connected (either directly or indirectly) to the structure. As noted above, in some examples structures to be retained by at least one of the robots (e.g., the first structure) may be additively manufactured with one or more features that facilitate engagement and retention of those structures by the at least one of the robots without the use of any fixtures.

In retaining the structure, keystone robot 507 may position (e.g., move) the structure; that is, the position of the structure may be controlled by keystone robot 507 when retained by the keystone robot. Keystone robot 507 may retain the structure by “holding” or “grasping” the structure, e.g., using an end effector of a robotic arm of the keystone robot. For example, keystone robot 507 may retain the structure by causing gripper fingers, jaws, and the like to contact one or more surfaces of the structure and apply sufficient pressure thereto such that the keystone robot controls the position of the structure. That is, the structure may be prevented from moving freely in space when retained by keystone robot 507, and movement of the structure may be constrained by the keystone robot. As described above, the structure may include one or more features that facilitates the fixtureless engagement and retention of the structure by keystone robot 507.

As other structures (including subassemblies, substructures of structures, etc.) are connected to the structure, keystone robot 507 may retain the engagement with the structure through the end effector. The aggregate of the structure and one or more structures connected thereto may be referred to as a structure itself, but may also be referred to as an “assembly” or a “subassembly.” Keystone robot 507 may retain an engagement with an assembly once the keystone robot has engaged the structure and may align the structures with respect to one another once engaged (e.g., in example implementation of bonding or otherwise using a bonding agent or adhesive to connect the structures).

Robots 509 and 511 of assembly system 500 may be similar to keystone robot 507 and, thus, may include respective end effectors configured to engage with structures that may be connected with the structure retained by the keystone robot. In some embodiments, robots 509, 511 may be referred to as “assembly robots” and/or “materials handling robots.” Robot 513 of assembly cell 505 may be used to affect a structural connection between structures. In the illustrative examples of FIG. 6C, robot 515 may be referred to as a “adhesive robot.” Adhesive robot 515 may be similar to the keystone robot 507, except the adhesive robot may include a tool at the distal end of the robotic arm that is configured to apply structural adhesive to at least one surface of structures fixturelessly retained by the keystone robot and structures fixturelessly retained by assembly robots 509, 511 before or after the structures are positioned at joining proximities with respect to other structures for joining with the other structures. The joining proximity can be a position that allows a first structure to be joined to a second structure. In some examples, the first and second structures may be joined though the application of an adhesive while the structures are within the joining proximity and subsequent curing of the adhesive.

However, structural adhesives might take time to cure. If this is the case, the robots retaining the first and second structures, for example, might have to hold the structures at the joining proximity for a period of time in order for the structures to be joined by the structural adhesive or bonding agent once it finally cures. In some examples a quick-cure adhesive can be used first to hold parts together temporarily and then an adhesive or bonding agent (which may have increased strength when compared to the quick cure adhesive) may be applied once the components are assembled.

In this regard, robot 515 of assembly system 500 may be used to apply quick-cure adhesive and to cure the adhesive quickly. In this example aspect, a quick-cure UV adhesive may be used, and robot 515 may be referred to as a “UV robot.” UV robot 515 may be similar to keystone robot 507, except the UV robot may include a tool at the distal end of the robotic arm that is configured to apply a quick-cure UV adhesive and to cure the adhesive, e.g., when a first structure is positioned within the joining proximity with respect to a second structure. That is, UV robot 515 may cure an adhesive after the adhesive is applied to the first structure and/or second structure when the structures are within the joining proximity obtained through direction of at least one of the robotic arms of keystone robot 507 and/or assembly robots 509, 511. In the aspects described above either a second robot (e.g., robot 513), or the same UV robot (515) may apply a subsequent or final bonding agent or adhesive.

In some aspects, at least partially replacing fixtures and/or other part-retention tools with curable adhesives may provide a more reliable connection at one or more locations on a structural assembly in need of support-particularly where such locations in need of support are rendered nearly or entirely inaccessible by the fixtures and/or other part-retention tools. In addition, at least partially replacing fixtures and/or other part-retention tools with curable adhesives may provide the ability to add more structures to a structural assembly before application of a (permanent) structural adhesive or bonding agent.

According to various aspects of the disclosure one or more of robots 507, 509, 511, 513, 515, 517 shown in FIG. 6A may be secured to a surface of assembly cell. In other aspects of the disclosure, one or more of the robots may include or may be connected with a component configured to move the robot within assembly cell. For example, a carrier 519 may be connected to robot 517.

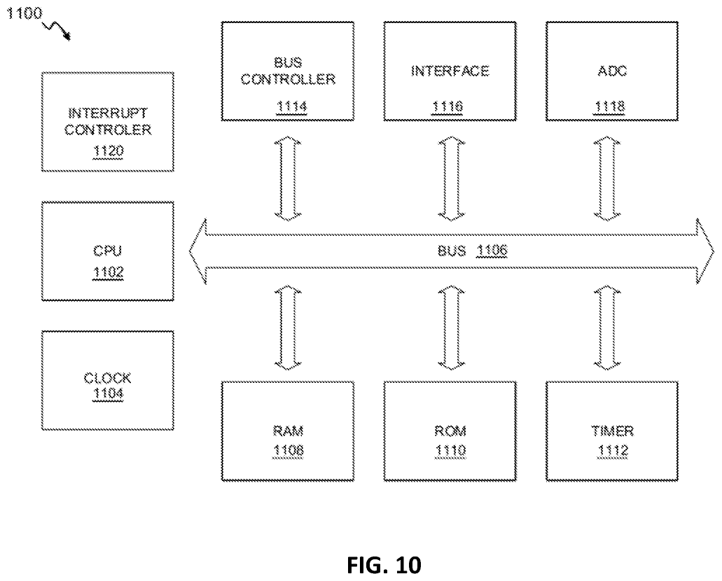

The assembly system may further include a control system for controlling operations described herein. In one example control system, each of the robots 507, 509, 511, 513, 515, 517 may be communicatively connected with a controller, such as a respective one of controllers 607, 609, 611, 613, 615, 617 shown in FIG. 6A. Each of controllers 607, 609, 611, 613, 615, 617 may include, for example, a memory and a processor communicatively connected to the memory (e.g., as described with respect to FIGS. 10-12, below). One or more of controllers 607, 609, 611, 613, 615, 617 may be implemented as a single controller that is communicatively connected to one or more of the robots controlled by the single controller.

Computer-readable instructions for performing fixtureless assembly can be stored on the memories of controllers 607, 609, 611, 613, 615, 617, and the processors of the controllers can execute the instructions to cause robots 507, 509, 511, 513, 515, 517 to perform various operations, such as those described with respect to FIGS. 6B through 6E.

Controllers 607, 609, 611, 613, 615, 617 may be communicatively connected to one or more components of an associated robot 507, 509, 511, 513, 515, or 517, for example, via a wired (e.g., bus or other interconnect) and/or wireless (e.g., wireless local area network, wireless intranet) connection. Each of the controllers may issue commands, requests, etc., to one or more components of the associated robot, for example, in order to perform various fixtureless operations. Controllers 607, 609, 611, 613, 615, 617 may issue commands, etc., to a robotic arm of the associated robot 507, 509, 511, 513, 515, or 517 and, for example, may direct the robotic arms based on a set of absolute coordinates relative to a global cell reference frame of assembly cell 505. In various embodiments, controllers 607, 609, 611, 613, 615, 617 may issue commands, etc., to tools connected to the distal ends of the robotic arms. For example, the controllers may control operations of the tool, including any one or a combination of the operations described above with respect to FIG. 5, and optionally may include exposing adhesive deposited between structures to UV light for a controlled duration by a curing tool. Controllers 607, 609, 611, 613, 615, 617 may issue commands, etc., to end effectors at the distal ends of the robotic arms. For example, the controllers may control operations of the end effectors, including, engaging, retaining, and/or manipulating the AM structures and non-AM structures described herein, for example to assemble and/or align components with respect to one another.

According to various other aspects, a computing system, such as computing system 529 (which may include features described below with respect to FIGS. 10-12), similarly having a processor and memory, may be communicatively connected with one or more of controllers 607, 609, 611, 613, 615, 617. In various embodiments, the computing system may be communicatively connected with the controllers via a wired and/or wireless connection, such as a local area network, an intranet, a wide area network, and so forth. In some examples, the computing system may be implemented in one or more of controllers 607, 609, 611, 613, 615, 617. In some other examples, the computing system may be located outside assembly cell 505.

The processor of the computing system may execute instructions loaded from memory, and the execution of the instructions may cause the computing system to issue commands, etc., to the controllers 607, 609, 611, 613, 615, 617, such as by transmitting a message including the command, etc., to one of the controllers over a network connection or other communication link.

In some examples, one or more of the commands may indicate a set of coordinates and may indicate an action to be performed by one of robots 507, 509, 511, 513, 515, 517 associated with the one of the controllers that receives the command. Examples of actions that may be indicated by commands include directing movement of a robotic arm, operating a tool, engaging a structure by an end effector, rotating and/or translating a structure, and so forth. For example, a command issued by a computing system may cause controller 611 of assembly robot 511 to direct a robotic arm of assembly robot 511 so that a distal end of the robotic arm may be located based on a set of coordinates that is indicated by the command.

The instructions loaded from memory and executed by the processor of the computing system, which cause the controllers to control actions of the robots may be based on computer-aided design (CAD) data. One or more CAD models may represent locations corresponding to various elements within the assembly cell 505. Specifically, a CAD model may represent the locations corresponding to one or more of robots 507, 509, 511, 513, 515, 517. In addition, a CAD model may represent locations corresponding to structures and repositories of the structures (e.g., storage elements, such as parts holder(s), within assembly system 500 at which structures may be located before being engaged by an assembly robot). The CAD model may represent sets of coordinates corresponding to respective initial or base positions of each of robots 507, 509, 511, 513, 515, 517.

For such CAD modeling, a reference frame for a coordinate system may be defined. The coordinate system may include absolute coordinates, relative coordinates, or a combination thereof. For a set of absolute coordinates, the coordinate frame may be a global coordinate frame or global cell reference frame, and the coordinate frame may include (e.g., may be bounded by and/or may be defined by) an assembly cell or area corresponding to the assembly system 500.

The coordinate frame may be established based on one or more ground references in-such as one or more laser prisms, each of which may be measured in the assembly cell so that, in the aggregate, a reference frame is defined with a number of reference points corresponding to the number of laser prisms. Thus, a CAD model corresponding to assembly area may be an as-built CAD model, which may represent the assembly area more accurately than a nominal CAD model. Absolute coordinates based on CAD modeling may provide a degree of accuracy that is acceptable for fixtureless assembly of components. In one example, directing robots 507, 509, 511, 513, 515, 517 based on absolute coordinates established through CAD modeling may adhere to various industry and/or safety standards that are to be observed when assembling a vehicle.

In some example implementations of the disclosure, relative coordinates may be used for assembly system 500, for example, as an alternative or supplement to an absolute coordinate system. In particular, relative coordinates may be used for some portions of the fixtureless joining process in which a second structure may be joined to the first structure and/or joined to another structure. For example, a controller associated with an assembly robot may direct robotic arm of the assembly robot to a joining position based on a set of absolute coordinates defined with respect to the global cell reference frame. The position of the robotic arm may be measured (e.g., by the controller of the assembly robot, by the controller of the keystone robot, by another controller and/or processing system, etc.) after assembly robot reaches the joining position based on the set of absolute coordinates, and the measured position of assembly robot may be provided to controller of the keystone robot. The controller of the keystone robot may position the robotic arm of the keystone robot based on the measured position of the assembly robot's robotic arm. Thus, the keystone robot's arm may be positioned relative to the assembly robot's arm, for example, instead of correcting the respective positions of each of the keystone robot and the assembly robot according to the global cell reference frame while the controllers may remain agnostic to the positions of the keystone robot or the assembly robot.

In addition, a CAD model may represent one or more of the operations that are to be performed for construction of at least an assembly or sub-assembly of components. In other words, a CAD model may simulate the assembly procedure of assembly system 500 and, therefore, may simulate each of the movements and/or actions performed by one or more of the robots. The CAD simulation may be translated into a set of discrete operations (e.g., a discrete operation may include direction for an associated set of coordinates), which may be physically performed by one or more of the robots.

Each of robots 507, 509, 511, 513, 515, 517 may include features that are common across all or some of the robots. Each robotic arm of robots 507, 509, 511, 513, 515, 517 may include a distal end, oppositely disposed from the proximal end of the robotic arm with an end effector and/or a tool, such as an adhesive application tool, curing tool, and so forth. An end effector or a tool may be at the distal end of a robotic arm. In some embodiments, the distal end of a robotic arm may be connected to an end effector or a tool (or tool flange) through at least one rotation and/or translation mechanism, which may provide at least one degree of freedom in movement of the tool and/or movement of a structure engaged and retained by the tool of the robotic arm.

In some aspects of the disclosure, the distal end of a robotic arm may include a tool flange, and a tool included at the tool flange; for example, a tool may be connected to the distal end of a robotic arm by means of the tool flange. A tool flange may be configured to include a plurality of tools. In this way, for example, the assembly robot 517 may offer functionality similar to each of the assembly robots 509, 511 when a distal end of a robotic arm of the assembly robot 517 includes an end effector (e.g., connected by means of the tool flange). In addition, the assembly robot 517 may offer functionality similar to the UV robot 515 when the distal end of the robotic arm of the assembly robot 517 includes a tool configured to apply UV adhesive and to emit UV light to cure a UV adhesive.

According to some embodiments, a tool flange and/or tool may provide one or more additional degrees of freedom (DoF) for rotation and/or translation of a structure engaged and retained by the tool. Such additional degrees of freedom may supplement the one or more degrees of freedom provided through one or more mechanisms connecting a base to the proximal end of a robotic arm and/or connecting the distal end of a robotic arm to the tool (or tool flange). Illustratively, a robotic arm of at least one of robots 507, 509, 511, 513, 515, 517 may include at least one joint configured for rotation and/or translation at a distal and/or proximal end, such as an articulating joint, a ball joint, and/or other similar joint.

One or more of the respective connections of robots 507, 509, 511, 513, 515, 517 (e.g., one or more rotational and/or translational mechanisms connecting various components of one of the robots), a respective tool flange, and/or a respective tool may provide at least a portion (and potentially all) of six DoF for a structure engaged and retained by the robots. The six DoF may include forward/backward (e.g., surge), up/down (e.g., heave), left/right (e.g., sway) for translation in space and may further include yaw, pitch, and roll for rotation in space.

Example operations of assembly system 500 will now be described in FIGS. 6A through 6D. As described herein, the example operations may be caused by at least one of controllers 607, 609, 611, 613, 615, 617 communicatively coupled with robots 507, 509, 511, 513, 515, 517. In some aspects, computing system 529 may issue commands to controllers 607, 609, 611, 613, 615, 617 to cause the example operations. Computing system 529 and/or controllers 607, 609, 611, 613, 615, 617 may cause the example operations based on CAD data, which may model the physical robots performing the example operations, and/or positional data, which may be provided by metrology system 531.

Referring first to FIG. 6B, assembly robot 511 can engage a non-AM component 525. The non-AM component 525 may include non-AM component bonding portion 534 with one or more other structures. As shown in the non-limiting example of FIG. 6B, the non-AM component bonding portion may be configured to fit-within an AM component bonding portion 533 of the AM component 523. In one example, the non-AM component 525 may be retrieved from any one of the parts holders 520, 521, and/or 522. Further the non-AM component 525 may be formed using any of the aforementioned non-AM processes and may be directly provided to or retrieved by the assembly robot 511 from a non-AM apparatus.

Assembly robot 511 may engage with non-AM component 525 with an effector or other holding or clamping apparatus at an appropriate portion of the non-AM component 525 e.g., approximately at a side of the non-AM component 525 that does not have non-AM component bonding portion 534. Once engaged, assembly robot 511 may retain non-AM component 525, e.g., by means of the end effector. When non-AM component 525 is retained by assembly robot 511, assembly robot 511 may move the non-AM component 525 to one or more positions at which one or more example operations of assembly may be performed, as further described below.

As further shown in FIG. 6B, the keystone robot 507 can engage AM component 523. AM component 523 may also include one or more features that enable joining of AM component 523 with one or more other structures. In the illustrated example, AM component 523 may include an opening or AM component bonding portion 533. In one example, the AM component 523 may be retrieved from any one of the parts holders 520, 521, and/or 522. Further the AM component 523 may be formed using any of the aforementioned AM processes and may be directly provided to or retrieved by the keystone robot 507 from an AM apparatus. Keystone robot 507 may be connected to an end effector. Illustratively, the distal end of the robotic arm of keystone robot 507 may be connected to end effector, which may be at the distal end of the robotic arm or may be attached to the robotic arm (and may be fixed or removable). The end effector of keystone robot 507 may be configured to engage (e.g., “pick up”) and retain the AM component 523. The keystone robot 507 may engage with AM component 523 at a surface and keystone robot 507 may then engage and retain AM component 533 at the first surface using the end effector.

With respect to FIG. 6B, keystone robot 507 may turn to face assembly robot 511, and the assembly robot may turn to face the keystone robot. The distal end of the robotic arm of keystone robot 507 may be positioned toward assembly robot 511, and similarly, the distal end of the robotic arm of assembly robot 511 may be positioned toward keystone robot 507.

In some aspects of the disclosure, keystone robot 507 may move AM component 523 according to one or more vectors, which may be based on CAD modeling. Each of the one or more vectors may indicate a magnitude (e.g., distance) and a direction according to which AM component 523 is to be moved by keystone robot 507. Each vector may be intended to bring AM component 523 to a desired position, and ultimately within joining proximity and then joining the AM component 523 and the non-AM component 525 and adjusting their relative positions for desired alignment as shown in FIG. 6E. Some vectors may be intermediary vectors intended to either position at least one of the AM component 523 and/or the non-AM component 525 into proximity of the adhesive robot 515 and/or in a position that is most suitable for application of the adhesive or bonding agent. As noted above, the adhesive or bonding agent may be applied to any one or both of the AM component bonding portion 533 and/or the non-AM component bonding portion 534 either before the two parts are joined together and/or may be applied or injected into a bond-gap between the non-AM component bonding portion 534 and the AM component bonding portion 533. Additional intermediate vectors may allow for “keying” or otherwise clearing internal paths or geometries of the AM component bonding portion 533 and/or the non-AM component bonding portion 534. One example of the keying or clearing of internal paths or geometries is described below with respect to FIGS. 7A-8C.

Once the AM component bonding portion 533 and the non-AM component 525 are installed (e.g., in the example shown, once the non-AM component 525 in installed into the AM component bonding portion 533), the assembly system 500 may align the two components to a desired position. In one example, the joining of the two structures that are engaged by robots in assembly system 500 may be accomplished using a “move-measure-correct” procedure. In effect, the move-measure-correct procedure may include moving at least one structure toward the joining proximity, measuring at least one difference between the current position of one of the structures (e.g., the physical position of the structure) and the position at which the structures can be joined (e.g., the joining proximity), and correcting the position of at least one of the structures such that the structures can be brought within the joining proximity, at which the structures can be joined. The move-measure-correct procedure may be repeated for one or more of the structures to be joined until the structures are brought within the joining proximity, at which point the joining operation can be accomplished such that the structures are joined (e.g., within acceptable tolerances). It is possible that the structures can be brought within the joining proximity in one step, thus repeating the procedure may not be necessary in all cases.

The move-measure-correct procedure may use metrology system 531, which may be configured to determine (e.g., detect, calculate, measure, capture, etc.) positional data, which may include a set of measurements or other values indicative of one or more positions of structures and/or robots (e.g., including robotic arms and/or components connected with robots, such as tools, flanges, end effectors, and so forth) and/or may include a set of measurements or values based on one or more locating points on the AM component 523 and/or the non-AM component 525. In some examples, as described above, the non-AM component 525 dimensions may be more critical (e.g., for locating other components to be mounted thereto), and thus measurements for alignment may be based on one or more surfaces or points of the non-AM component 525. The metrology system 531 may include any one or combination of a tracker-machine control sensor (T-MAC), a laser metrology device (e.g., configured for laser scanning and/or tracking), a photogrammetry device, a camera (e.g., configured to capture still images and/or video), and/or another device configured to similarly determine positional data.

In some aspects of this disclosure, after adhesive or bonding agent is applied and the AM component 523 the non-AM component 525 properly installed or aligned, the assembly robot 511 and the keystone robot 507 may hold the two components in place until the adhesive or bonding agent cures. In some examples, the adhesive or bonding agent may be UV curing. In such an example, the adhesive robot 515 and/or a separate UV robot (not shown) may include a UV light or series of lights to apply UV light to the bonding agent or adhesive. In another example, after the AM component 523 the non-AM component 525 properly installed or aligned a set quantity of UV adhesive may be applied and cured to hold to temporarily bond the two components (and retain the relative position of the two components) and a structural adhesive (which may be slower to cure or may require that the combination component be placed in an autoclave) may be applied and cured either manually or with any one or combination of the aforementioned robots 507, 509, 511, 513, 515, and/or 517). In yet another example, any of the aforementioned components may directly apply heat to the component to cure the adhesive or bonding agent.

FIGS. 7A and 7B show partial views of examples of a component according to aspects of the disclosure. While the component 623 may be formed using AM or non-AM techniques, in the description that follows the component will be referred to as an AM component. In some examples, the AM component 623 may be analogous with or share features with the AM component 523 described above with respect to FIGS. 6B-6E. Further, while not intended to be limiting, the AM component may be manufactured or otherwise formed using any of the AM methods described herein including the examples described above with respect to FIGS. 1A-3.

The AM component 623 may include an AM component bonding portion 633, which may take the broad shape of a blind hole or opening. It is noted that while a blind hole or opening is shown, the AM component bonding portion 633 may take may other forms, which include but are not limited to a through-hole or opening, a cavity, a channel, and/or a tunnel. In some examples, the AM component bonding portion 633 may include one or more keyways or other features that increase the surface area within the AM component bonding portion 633 and/or that are configured to correspond with features of a component to be bonded or adhered into the AM component bonding portion 633.

In the illustrative example of FIGS. 7A and 7B, the AM component bonding portion 633 includes a first AM keyway feature 706 and a second component keyway feature 707, which may be interchangeably referred to as an AM keyway feature. The AM component 623 may be part of a larger component or a subcomponent. In some examples the AM component 623 may be a component that benefits from or requires the capabilities of an AM manufacturing method described above. Further, the AM component may be a component that may be subject to dimensional variances due to the AM process and/or that may not require the strength or dimensional stability that may be associated with some non-AM components.

FIGS. 7C and 7D show partial views of examples of a second component according to aspects of the disclosure. While the components 725a and 725b may be formed using AM or non-AM techniques, in the description that follows the components 725a and 725b will be referred to as non-AM components. In some examples, the non-AM components 725a and/or 725b may be analogous with or share features with the non-AM component 525 described above with respect to FIGS. 6B-6E. Further, while not intended to be limiting, the non-AM component may be manufactured or otherwise formed using any one or combination of the non-AM methods described herein, including the examples described above with respect to FIGS. 4A and 4B.

The non-AM components 725a and 725b may include non-AM component bonding portions 734a and 734b. It is noted that while round-cross section protrusion or rod-shaped structure is shown, the AM component may take may other forms, which include but are not limited to protrusion having any known cross-section (e.g., oval, square, rectangular, star-shaped, octagonal, or combinations thereof). In some examples, the non-AM component bonding portions 734a and/or 734b may include one or more first key portions 806a and 806b and/or second key portions 807a and 807b. The aforementioned first and second key portions may be interchangeably referred to throughout this disclosure as a machined component keyway feature or non-AM keyway feature. Further, while the key features are shown as tab-shaped protrusions any type of feature or surface irregularity that increases the surface area of the non-AM component bonding portions 734a and/or 734b and/or that are configured to correspond with keyway features of the AM component bonding portion 633 may be utilized without departing from the scope of this disclosure.

The non-AM components 725a and/or 725 may be formed with a mating surface or surfaces 711a and/or 711b that may be configured to connect to other components. In some examples, the mating surfaces 711a and/or 711b may have require tighter tolerances or higher dimensional accuracy than may be achieved when manufacturing a component using AM methods. As noted above, the entire non-AM component and/or a portion of (e.g., the mating surfaces 711a and/or 711b) may for example be milled or machined to achieve such dimensional accuracy or tight tolerances. In another example, the mating surfaces 711a and/or 711b may require higher dimensional stability (i.e., over a wider range of temperatures) and/or improved strength or toughness that may be typically achieved when manufacturing a component using typical AM methods. For example, the non-AM component may be forged, subject to heat/cold treatments, and/or formed of materials that are not typically used to form AM components.

FIGS. 8A-8C show examples of the assembly of the non-AM component 725 (which may include features of either 725a and/or 725b described above) and the AM component 623 described above according to one example implementation of aspects of this disclosure. It is noted that the assembly described with respect to FIGS. 8A-8C may be analogous with or share features with the steps described above with respect to FIG. 5. Further, the components may be manually assembled or may be assembled with any one, combination, or using all of the automated features described above with respect to FIGS. 6A-6E.

Either before or after an adhesive or bonding agent is applied to either one of or both of the non-AM component 725 and/or the AM component 623, the non-AM component 725 may be aligned with and moved towards the AM component bonding portion 633 in direction II, which may be a linear direction. Once the second key portion 807 clears the first AM component keyway 706, the non-AM component 725a may be rotated in direction RR. In one example, the non-AM component 725a may be rotated in direction RR approximately 90 degrees so that the second key portion 807 can clear the second AM component keyway 707 and the first key portion 806 can clear the first AM component keyway 706. Further, as shown in FIG. 8C, once the second key portion 807 clears the second AM component keyway 707, the non-AM component 725 may again be rotated in direction RR (e.g., 90 degrees) so that the second key portion 807 would interfere with the second AM component keyway if the non-AM component and the AM component were pulled apart in a linear direction (i.e., opposite the directions indicated by arrows II and/or III). The AM component 623 and/or the non-AM component 623 can then be aligned with respect to one another either before the adhesive in the bond-gap cures and/or as the adhesive in the bond-gap cures. The bond-gap is dimensioned to allow to compensation for and/or to absorb any dimensional variances or irregularities of the AM component 623 and/or the non-AM component 725. In some examples, the components may be aligned using one or more reference points on the non-AM component 725, so that any dimensional variations of the AM component do not effect or minimally effect the mounting points (e.g., mating surfaces 711a and/or 711b) of the finished combined component. The aforementioned alignment may further be automated or semi-automated using any one or combination of the features described above with respect to FIGS. 6A-6E. Once the components are aligned, the adhesive or bonding agent that fills the bond-gap 819 may then be allowed to cure or cured.

It is noted that while in the example above, movement of the non-AM component 725 is described with respect to the AM component 623, the AM component 623 can be moved instead (e.g., in direction III) to achieve the same results. Similarly, both the AM component 623 and the non-AM component 725 can be move simultaneously and/or in steps to achieve the same assembly results. Further, similar results could be achieved by rotating any one or both of the AM component 623 and the non-AM components. The rotation direction RR may also be reversed during the installation process.

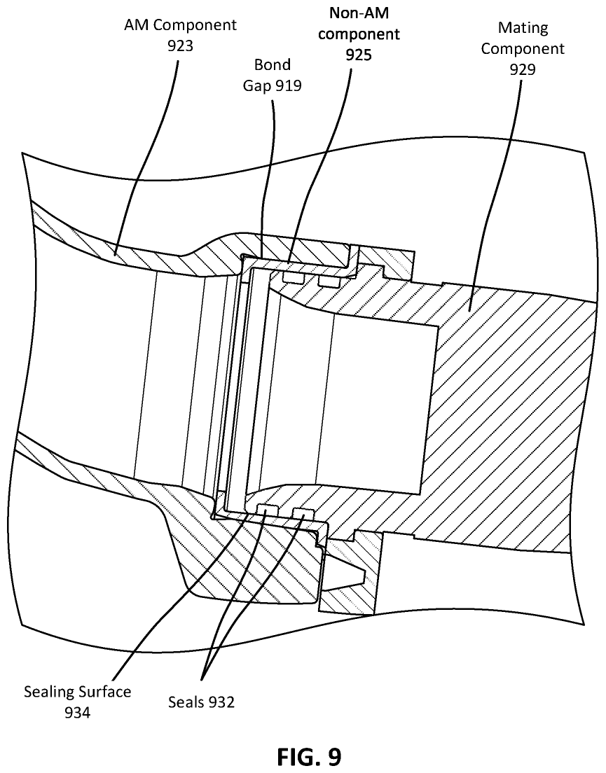

FIG. 9 shows another example of a combination component according to aspects of this disclosure. As shown in FIG. 9, an AM component may be configured to be assembled or otherwise connected to a mating component 929. The AM component 923 may be formed using any of the AM methods described herein. The combination component of FIG. 9 may for example be a passage for containing or otherwise having a fluid flow therethrough. The mating component may include one or more seal 932, which may for example be o-rings. In some examples, the interface or seal between the seals 932 and the sealing surface 934 may require any one or combination of a high dimensional precision, high degree of manufacturing repeatability, high dimensional stability over a range of temperatures and conditions and/or a surface finish that may be difficult to achieve using the AM methods described herein. Accordingly, a non-AM component that is formed using any one or combination of the features described herein may be adhered to or bonded to a receiving portion or an AM component bonding portion of AM component 923. The bonding and/or alignment of the non-AM component 925 and the AM component 923 may be achieved through any one or combination of the aspects described herein. As noted above, the entire non-AM component and/or a portion of (e.g., the sealing surface 934) may for example be milled or machined to achieve such dimensional accuracy or tight tolerances. In another example, the sealing surface 934 may provide a higher dimensional stability (i.e., over a wider range of temperatures) and/or improved strength or toughness that may be typically achieved when manufacturing a component using typical AM methods, thus improving the quality of the seal at the sealing surface 934 and the seals 932 of the mating component 929.

It is noted that the aforementioned operations are provided as examples. While some specific examples are given, one having ordinary skill in the art would understand that additional possibilities of automated, semi-automated, or manual control of the systems and devices disclosed. In some implementations, as part of or incorporating various features and methods described herein, one or more microcontrollers may be implemented for controlling any one or combination of the operations described herein (e.g., the operations of the AM system, non-AM system, and/or assembly system). Various components of an example of such a controller 1100 are shown in representative block diagram form in FIG. 10. In FIG. 10, the controller 1100 includes a CPU 1102, clock 1104, RAM 1108, ROM 1110, a timer 1112, a BUS controller 1114, an interface 1116, and an analog-to-digital converter (ADC) 1118 interconnected via a BUS 1106. The CPU 1102 may be implemented as one or more single core or multi-core processors, and receive signals from an interrupt controller 1120 and a clock 1104. The clock 1104 may set the operating frequency of the entire microcontroller 1100 and may include one or more crystal oscillators having predetermined frequencies. Alternatively, the clock 1104 may receive an external clock signal. The interrupt controller 1120 may also send interrupt signals to the CPU, to suspend CPU operations. The interrupt controller 1120 may transmit an interrupt signal to the CPU when an event requires immediate CPU attention.

The RAM 1108 may include one or more Static Random Access Memory (SRAM), Dynamic Random Access Memory (DRAM), Synchronous Dynamic Random Access Memory (SDRAM), Double Data-Rate Random Access Memory (DDR SDRAM), or other suitable volatile memory. The Read-only Memory (ROM) 1110 may include one or more Programmable Read-only Memory (PROM), Erasable Programmable Read-only Memory (EPROM), Electronically Erasable Programmable Read-only memory (EEPROM), flash memory, or other types of non-volatile memory.

The timer 1112 may keep time and/or calculate the amount of time between events occurring within the controller 1100, count the number of events, and/or generate baud rate for communication transfer. The BUS controller 1114 may prioritize BUS usage within the controller 1100. The ADC 1118 may allow the controller 1100 to send out pulses to signal other devices.

The interface 1116 may comprise an input/output device that allows the controller 1100 to exchange information with other devices. In some implementations, the interface 1116 may include one or more of a parallel port, a serial port, or other computer interfaces.

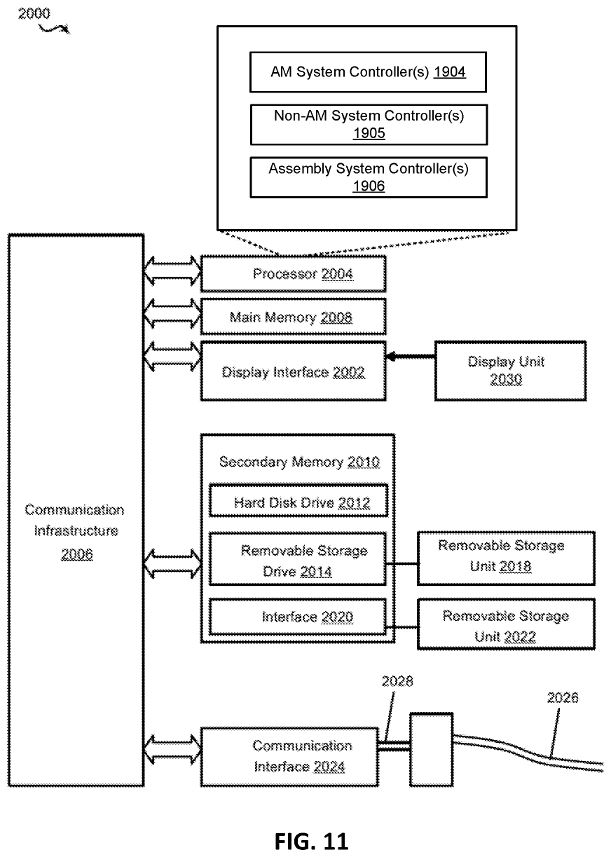

In addition, aspects of the present disclosures may be implemented using hardware, software, or a combination thereof and may be implemented in one or more computer systems or other processing systems. In an aspect of the present disclosures, features are directed toward one or more computer systems capable of carrying out the functionality described herein. An example of such the computer system 2000 is shown in FIG. 11.

The computer system 2000 may include one or more processors, such as processor 2004. The processor 2004 may be connected to a communication infrastructure 2006 (e.g., a communications bus, cross-over bar, or network). Various software aspects are described in terms of this example computer system. After reading this description, it will become apparent to a person skilled in the relevant art(s) how to implement aspects of the disclosures using other computer systems and/or architectures.

The computer system 2000 may include a display interface 2002 that forwards graphics, text, and other data from the communication infrastructure 2006 (or from a frame buffer not shown) for display on a display unit 2030, Computer system 2000 also includes a main memory 2008, preferably random access memory (RAM), and may also include a secondary memory 2010. The secondary memory 2010 may include, for example, a hard disk drive 2012, and/or a removable storage drive 2014, representing a floppy disk drive, a magnetic tape drive, an optical disk drive, a universal serial bus (USB) flash drive, etc. The removable storage drive 2014 reads from and/or writes to a removable storage unit 2018 in a well-known manner. Removable storage unit 2018 represents a floppy disk, magnetic tape, optical disk, USB flash drive etc., which is read by and written to removable storage drive 2014. As will be appreciated, the removable storage unit 2018 includes a computer usable storage medium having stored therein computer software and/or data.

Alternative aspects of the present disclosure may include secondary memory 2010 and may include other similar devices for allowing computer programs or other instructions to be loaded into computer system 2000. Such devices may include, for example, a removable storage unit 2022 and an interface 2020. Examples of such may include a program cartridge and cartridge interface (such as that found in video game devices), a removable memory chip (such as an erasable programmable read only memory (EPROM), or programmable read only memory (PROM)) and associated socket, and other removable storage units 2022 and interfaces 2020, which allow software and data to be transferred from the removable storage unit 2022 to computer system 2000.

Computer system 2000 may also include a communications interface 2024. Communications interface 2024 allows software and data to be transferred between computer system 2000 and external devices. Examples of communications interface 2024 may include a modem, a network interface (such as an Ethernet card), a communications port, a Personal Computer Memory Card International Association (PCMCIA) slot and card, etc. Software and data transferred via communications interface 2024 are in the form of signals 2028, which may be electronic, electromagnetic, optical or other signals capable of being received by communications interface 2024. These signals 2028 are provided to communications interface 2024 via a communications path (e.g., channel) 2026. This path 2026 carries signals 2028 and may be implemented using wire or cable, fiber optics, a telephone line, a cellular link, an RF link and/or other communications channels. In this document, the terms “computer program medium” and “computer usable medium” are used to refer generally to media such as a removable storage drive 2018, a hard disk installed in hard disk drive 2012, and signals 2028. These computer program products provide software to the computer system 2000. Aspects of the present disclosures are directed to such computer program products.

Computer programs (also referred to as computer control logic) are stored in main memory 2008 and/or secondary memory 2010. Computer programs may also be received via communications interface 2024. Such computer programs, when executed, enable the computer system 2000 to perform the features in accordance with aspects of the present disclosures, as discussed herein. In particular, the computer programs, when executed, enable the processor 2004 to perform the features in accordance with aspects of the present disclosures. Accordingly, such computer programs represent controllers of the computer system 2000.

In an aspect of the present disclosures where the method is implemented using software, the software may be stored in a computer program product and loaded into computer system 2000 using removable storage drive 2014, hard drive 2012, or communications interface 2020. The control logic (software), when executed by the processor 2004, causes the processor 2004 to perform the functions described herein. In some examples, the computer system 2000 may include one or more AM controller(s) 1904, e.g., for controlling any one or combination of the AM systems described above with respect to FIGS. 1A-3 and/or non-AM system controller 1905 for controlling any one or combination of the non-AM systems described above with respect to FIGS. 4A and 4B and/or an assembly system controller 1906 for controlling any one or combination of the assembly systems described above with respect to FIGS. 6B-6E. In another aspect of the present disclosures, the system is implemented primarily in hardware using, for example, hardware components, such as application specific integrated circuits (ASICs). Implementation of the hardware state machine so as to perform the functions described herein will be apparent to persons skilled in the relevant art(s).

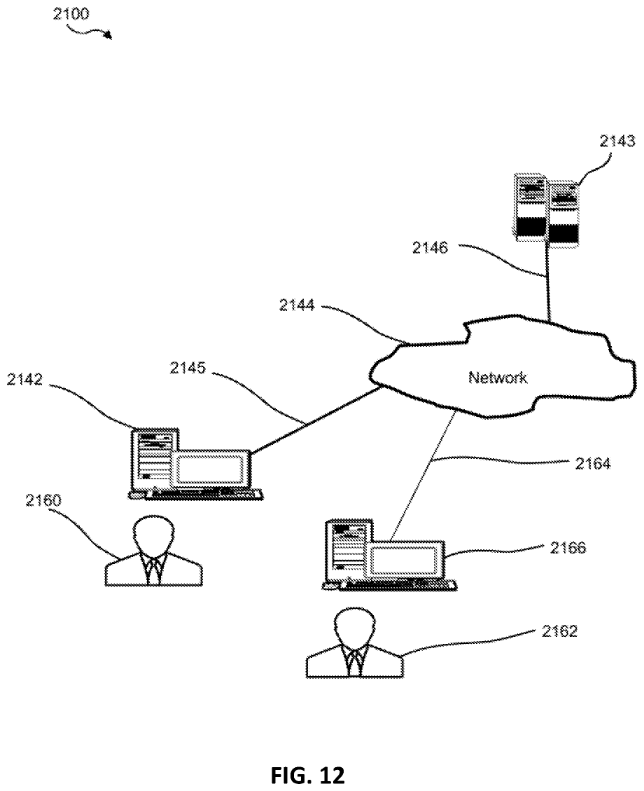

FIG. 12 is a block diagram of various example communication system components usable in accordance with an aspect of the present disclosure. The communication system 2100 includes one or more accessors 2160, 2162 (which may for example comprise any of the aforementioned systems and features) and one or more terminals 2142, 2166. In one aspect, data for use in accordance with aspects of the present disclosure is, for example, input and/or accessed by accessors 2160, 2162 via terminals 2142, 2166, such as personal computers (PCs), minicomputers, mainframe computers, microcomputers, telephonic devices, or wireless devices, such as personal digital assistants (“PDAs”) or a hand-held wireless devices coupled to a server 2143, such as a PC, minicomputer, mainframe computer, microcomputer, or other device having a processor and a repository for data and/or connection to a repository for data, via, for example, a network 2144, such as the Internet or an intranet, and couplings 2145, 2146, 2164. The couplings 2145, 2146, 2164 include, for example, wired, wireless, or fiberoptic links. In another example variation, the method and system in accordance with aspects of the present disclosure operate in a stand-alone environment, such as on a single terminal.

Additional aspects of the disclosure are described in the following clauses:

Clause 1. A method of producing a vehicle component by joining an additively manufactured (“AM”) component with a machined component, the method comprising: retaining the AM component with a first robot, wherein the AM component has an AM component bonding portion; retaining the machined component with a second robot, wherein the machined component has a machined component bonding portion that is configured to be bonded with the AM component bonding portion with a bond gap therebetween for absorbing dimensional variances in the AM component; and adjusting one of a position of the machined component or the AM component to achieve a designated alignment of the AM component with the machined component, wherein an adhesive in the bond gap bonds the AM component bonding portion and the machined component bonding portion.

Clause 2. The method of clause 1, wherein AM component bonding portion is configured to receive the machined component bonding portion with a bond gap therebetween.

Clause 3. The method of any of the preceding clauses, wherein the machined component comprises a machined component keyway feature and the AM component comprises an AM keyway feature, wherein the machined component keyway feature and the AM keyway feature are configured to prevent assembly or separation of the machined component and the AM component along a single axis.

Clause 4. The method of any of the preceding clauses, wherein the single axis is a linear axis.

Clause 5. The method of any of the preceding clauses, wherein the machined component keyway feature and the AM component keyway feature are configured require a combination of linear and rotational movements for assembly or separation of the machined component and the AM component.

Clause 6. The method of any of the preceding clauses, wherein the adhesive is provided to at least one of the AM component or the machined component prior to adjusting the at least one of the positions of the machined component or the AM component.

Clause 7. The method of any of the preceding clauses, wherein the adhesive is provided to the bond gap between the AM component and the machined component after the said adjusting of the one of the position of the machined component and the AM component.

Clause 8. A vehicle component comprising: an additively manufactured (“AM”) component with an AM component bonding portion; a non-AM component with a non-AM component bonding portion; and a bonding agent within a bond gap between the AM component bonding portion and the non-AM component bonding portion, wherein the bonding agent in the bond gap between AM component and the non-AM component permanently connects the AM component with the non-AM component.

Clause 9. The vehicle component of clause 8, wherein the non-AM component bonding portion is within the AM component bonding portion with the bonding agent therebetween.

Clause 10. The vehicle component of any of the preceding clauses, wherein the AM component bonding portion is within the non-AM component bonding portion with the bonding agent therebetween.

Clause 11. The vehicle component of any of the preceding clauses, wherein the non-AM component bonding portion comprises a non-AM component keyway feature and the AM component bonding portion comprises an AM keyway feature, wherein the non-AM component keyway feature and the AM keyway feature are configured to retain the non-AM component to the AM component.

Clause 12. The vehicle component of any of the preceding clauses, wherein the non-AM component is machined from material stock.

Clause 13. The vehicle component of any of the preceding clauses, wherein the non-AM component has a machined portion.

Clause 14. A method of producing a vehicle component by joining an additively manufactured (“AM”) component with a non-AM component, the method comprising: retaining the AM component, wherein the AM component has an AM component bonding portion; retaining the non-AM component, wherein the non-AM component has a non-AM component bonding portion that is configured to be bonded with the AM component bonding portion with a bond gap therebetween for absorbing dimensional variances in the AM component or the non-AM component; and adjusting one of a position of the non-AM component or the AM component to achieve a designated alignment of the AM component with the non-AM component, wherein an adhesive in the bond gap bonds the AM component bonding portion and the non-AM component bonding portion.

Clause 15. The method of clause 14, wherein AM component bonding portion is configured to receive the non-AM component bonding portion with a bond gap therebetween.

Clause 16. The method of any of the preceding clauses, wherein the non-AM component comprises a non-AM component keyway feature and the AM component comprises an AM keyway feature, wherein the non-AM component keyway feature and the AM component keyway feature are configured to prevent assembly or separation of the non-AM component and the AM component along a single axis.

Clause 17. The method of any of the preceding clauses, wherein the single axis is a linear axis.

Clause 18. The method of any of the preceding clauses, wherein the non-AM component comprises a non-AM component keyway feature and the AM component comprises an AM keyway feature, wherein the non-AM component keyway feature and the AM component keyway feature are configured require a combination of linear and rotational movements for assembly or separation of the non-AM component and the AM component.

Clause 19. The method of any of the preceding clauses, wherein the adhesive is provided to at least one of the AM component or the non-AM component prior to adjusting the at least one of the positions of the non-AM component or the AM component.

Clause 20. The method of any of the preceding clauses, wherein the adhesive is provided to the bond gap between the AM component and the non-AM component after the said adjusting of the one of the position of the non-AM component and the AM component.

Clause 21. The method of any of the preceding clauses, wherein the non-AM component comprises a machined surface, wherein the machined surface proves a reference point for alignment of the non-AM component and the AM component.

The present disclosure is provided to enable any person skilled in the art to practice the various aspects described herein. Various modifications to these example embodiments presented throughout the present disclosure will be readily apparent to those skilled in the art, and the concepts disclosed herein may be applied to other techniques for printing nodes and interconnects. Thus, the claims are not intended to be limited to the example embodiments presented throughout the disclosure, but are to be accorded the full scope consistent with the language claims. All structural and functional equivalents to the elements of the example embodiments described throughout the present disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A method of producing a vehicle component by joining an additively manufactured (“AM”) component with a machined component, the method comprising:
retaining the AM component with a first robot, wherein the AM component has an AM component bonding portion;
retaining the machined component with a second robot, wherein the machined component has a machined component bonding portion that is configured to be bonded with the AM component bonding portion with a bond gap therebetween for absorbing dimensional variances in the AM component; and
adjusting one of a position of the machined component or the AM component to achieve a designated alignment of the AM component with the machined component, wherein an adhesive in the bond gap bonds the AM component bonding portion and the machined component bonding portion.

2. The method of claim 1, wherein AM component bonding portion is configured to receive the machined component bonding portion with a bond gap therebetween.

3. The method of claim 2, wherein the machined component comprises a machined component keyway feature and the AM component comprises an AM keyway feature, wherein the machined component keyway feature and the AM keyway feature are configured to prevent assembly or separation of the machined component and the AM component along a single axis.

4. The method of claim 3, wherein the single axis is a linear axis.

5. The method of claim 4, wherein the machined component keyway feature and the AM component keyway feature are configured require a combination of linear and rotational movements for assembly or separation of the machined component and the AM component.

6. The method of claim 1, wherein the adhesive is provided to at least one of the AM component or the machined component prior to adjusting the at least one of the positions of the machined component or the AM component.

7. The method of claim 1, wherein the adhesive is provided to the bond gap between the AM component and the machined component after the said adjusting of the one of the position of the machined component and the AM component.

8. A vehicle component comprising:
an additively manufactured (“AM”) component with an AM component bonding portion;
a non-AM component with a non-AM component bonding portion; and
a bonding agent within a bond gap between the AM component bonding portion and the non-AM component bonding portion, wherein the bonding agent in the bond gap between AM component and the non-AM component permanently connects the AM component with the non-AM component.

9. The vehicle component of claim 8, wherein the non-AM component bonding portion is within the AM component bonding portion with the bonding agent therebetween.

10. The vehicle component of claim 8, wherein the AM component bonding portion is within the non-AM component bonding portion with the bonding agent therebetween.

11. The vehicle component of claim 8, wherein the non-AM component bonding portion comprises a non-AM component keyway feature and the AM component bonding portion comprises an AM keyway feature, wherein the non-AM component keyway feature and the AM keyway feature are configured to retain the non-AM component to the AM component.

12. The vehicle component of claim 8, wherein the non-AM component is machined from material stock.

13. The vehicle component of claim 8, wherein the non-AM component has a machined portion.

14. A method of producing a vehicle component by joining an additively manufactured (“AM”) component with a non-AM component, the method comprising:
retaining the AM component, wherein the AM component has an AM component bonding portion;
retaining the non-AM component, wherein the non-AM component has a non-AM component bonding portion that is configured to be bonded with the AM component bonding portion with a bond gap therebetween for absorbing dimensional variances in the AM component or the non-AM component; and
adjusting one of a position of the non-AM component or the AM component to achieve a designated alignment of the AM component with the non-AM component, wherein an adhesive in the bond gap bonds the AM component bonding portion and the non-AM component bonding portion.

15. The method of claim 14, wherein AM component bonding portion is configured to receive the non-AM component bonding portion with a bond gap therebetween.

16. The method of claim 15, wherein the non-AM component comprises a non-AM component keyway feature and the AM component comprises an AM keyway feature, wherein the non-AM component keyway feature and the AM component keyway feature are configured to prevent assembly or separation of the non-AM component and the AM component along a single axis.

17. The method of claim 16, wherein the single axis is a linear axis.

18. The method of claim 14, wherein the non-AM component comprises a non-AM component keyway feature and the AM component comprises an AM keyway feature, wherein the non-AM component keyway feature and the AM component keyway feature are configured require a combination of linear and rotational movements for assembly or separation of the non-AM component and the AM component.

19. The method of claim 14, wherein the adhesive is provided to at least one of the AM component or the non-AM component prior to adjusting the at least one of the positions of the non-AM component or the AM component.

20. The method of claim 14, wherein the adhesive is provided to the bond gap between the AM component and the non-AM component after the said adjusting of the one of the position of the non-AM component and the AM component.

21. The method of claim 14, wherein the non-AM component comprises a machined surface, wherein the machined surface proves a reference point for alignment of the non-AM component and the AM component.
